(19) United States
(12) Patent Application Publication
(10) Pub. No.: US 2021/0024082 A1
(43) Pub. Date: Jan. 28, 2021

(54) TRAFFIC SIGNAL INTERPRETATION SYSTEM AND VEHICLE CONTROL SYSTEM

(71) Applicant: Toyota Jidosha Kabushiki Kaisha, Toyota-shi Aichi-ken (JP)

(72) Inventors: Yusuke Hayashi, Susono-shi (JP); Taichi Kawanai, Susono-shi (JP)

(21) Appl. No.: 16/935,856

(22) Filed: Jul. 22, 2020

(30) Foreign Application Priority Data
Jul. 23, 2019 (JP) 2019-135524

(51) Int. Cl. B60W 60/00; B60W 40/04; G06K 9/00; B60W 30/18

(52) U.S. Cl. CPC B60W 60/001; B60W 40/04; B60W 2050/0089; B60W 30/18154; B60W 2555/60; G06K 9/00825

(57) ABSTRACT

A traffic signal interpretation system applied to a vehicle sets an action pattern of a vehicle with respect to a target area where a traffic signal is installed. Corresponding pattern information indicates a correspondence relationship between a lighting state of the traffic signal and the action pattern. Rule information indicates a rule that permits or prohibits a transition of the action pattern. The traffic signal interpretation system refers to the corresponding pattern information to acquire the action pattern corresponding to the lighting state as a provisional action pattern. When the provisional action pattern becomes one different from a previous action pattern, the traffic signal interpretation system sets a current action pattern by correcting a transition from the previous action pattern to the provisional action pattern so as to be consistent with the rule indicated by the rule information.

### CROSS-REFERENCE TO RELATED APPLICATION

This application claims priority to Japanese Patent Application No. 2019-135524 filed on Jul. 23, 2019, the entire contents of which are herein incorporated by reference.

### BACKGROUND

### Technical Field

The present disclosure relates to a traffic signal interpretation system that is applied to a vehicle executing automated driving and interprets a lighting state of a traffic signal to set a vehicle action pattern. In addition, the present disclosure relates to a vehicle control system having the traffic signal interpretation system.

### Background Art

Patent Literature 1 discloses a method for detecting a traffic signal and its state. The method first scans a target area by using a sensor mounted on a vehicle to obtain information (image) of the target area. Here, the target area is a typical area in which a traffic signal exists. Subsequently, the method detects a traffic signal in the target area information to detect a position of the traffic signal. Furthermore, the method determines a state of the detected traffic signal (e.g., green, yellow, red, or unclear) based on brightness. For example, when green brightness is the highest, it is determined that the state of the detected traffic signal is green.

### LIST OF RELATED ART

Patent Literature 1: U.S. Laid-Open Patent Application Publication No. 2013/0253754

### SUMMARY

A vehicle travels in accordance with a lighting state (signal indication) of a traffic signal. It is important for achieving automated driving of the vehicle not only to recognize the lighting state of the traffic signal but also to interpret a meaning of the recognized lighting state to set an appropriate vehicle action pattern corresponding to the recognized lighting state. However, the vehicle action pattern obtained based only on a result of recognition of the lighting state of the traffic signal is not always appropriate.

An object of the present disclosure is to provide a technique that can interpret a lighting state of a traffic signal to more appropriately set a vehicle action pattern.

A first aspect is directed to a traffic signal interpretation system applied to a vehicle executing automated driving.

The traffic signal interpretation system includes:

one or more processors configured to at least set an action pattern of the vehicle with respect to a target area where a traffic signal is installed; and

one or more memory devices configured to store:

traffic signal state information indicating a lighting state of the traffic signal;

corresponding pattern information indicating a correspondence relationship between the lighting state of the traffic signal and the action pattern; and

rule information indicating a rule that permits or prohibits a transition of the action pattern.

The one or more processors are further configured to:

refer to the corresponding pattern information to acquire the action pattern corresponding to the lighting state indicated by the traffic signal state information as a provisional action pattern; and

when the provisional action pattern becomes one different from a previous action pattern, set a current action pattern by correcting a transition from the previous action pattern to the provisional action pattern so as to be consistent with the rule indicated by the rule information.

A second aspect is directed to a traffic signal interpretation system applied to a vehicle executing automated driving.

The traffic signal interpretation system includes:

one or more processors configured to at least set an action pattern of the vehicle with respect to a target area where a traffic signal is installed; and

one or more memory devices configured to store:

traffic signal state information indicating a lighting state of the traffic signal;

corresponding pattern information indicating a correspondence relationship between the lighting state of the traffic signal and the action pattern; and

surrounding vehicle information indicating a vehicle behavior of a surrounding vehicle around the vehicle with respect to the target area.

The one or more processors are further configured to:

refer to the corresponding pattern information to acquire the action pattern corresponding to the lighting state indicated by the traffic signal state information as a provisional action pattern; and

set the action pattern by correcting the provisional action pattern so as to be consistent with the vehicle behavior of the surrounding vehicle.

A third aspect is directed to a vehicle control system having the above-described traffic signal interpretation system.

The one or more processors are further configured to generate a travel plan of the vehicle during the automated driving based on the action pattern and control the vehicle to travel in accordance with the travel plan.

According to the first aspect, the traffic signal interpretation system sets the action pattern of the vehicle with respect to the target area where the traffic signal is installed, based on the traffic signal state information, the corresponding pattern information, and the rule information. More specifically, the traffic signal interpretation system refers to the corresponding pattern information to acquire the action pattern corresponding to the lighting state indicated by the traffic signal state information as the provisional action pattern. The rule information indicates the rule that permits or prohibits a transition of the action pattern. When the provisional action pattern becomes one different from the previous action pattern, the traffic signal interpretation system sets the current action pattern by correcting the transition from the previous action pattern to the provisional action pattern so as to be consistent with the rule indicated by the rule information. It is thus possible to more appropriately set the action pattern with respect to the target area.

According to the second aspect, the traffic signal interpretation system sets the action pattern of the vehicle with respect to the target area where the traffic signal is installed, based on the traffic signal state information, the corresponding pattern information, and the surrounding vehicle information. More specifically, the traffic signal interpretation system refers to the corresponding pattern information to acquire the action pattern corresponding to the lighting state indicated by the traffic signal state information as the provisional action pattern. The surrounding vehicle information indicates the vehicle behavior of the surrounding vehicle with respect to the target area. The traffic signal interpretation system sets the action pattern by correcting the provisional action pattern so as to be consistent with the vehicle behavior of the surrounding vehicle. It is thus possible to more appropriately set the action pattern with respect to the target area.

### BRIEF DESCRIPTION OF DRAWINGS

FIG. 1 is a conceptual diagram for explaining an outline of a first embodiment of the present disclosure;

FIG. 2 is a conceptual diagram showing examples of basic action patterns in the first embodiment of the present disclosure;

FIG. 3 is a conceptual diagram for explaining an action pattern corresponding to a lighting state LG of a traffic signal in the first embodiment of the present disclosure;

FIG. 4 is a conceptual diagram for explaining priority of the action pattern in the first embodiment of the present disclosure;

FIG. 5 is a conceptual diagram for explaining an action pattern corresponding to a lighting state LY of a traffic signal in the first embodiment of the present disclosure;

FIG. 6 is a conceptual diagram for explaining an action pattern corresponding to a lighting state LR of a traffic signal in the first embodiment of the present disclosure;

FIG. 7 is a conceptual diagram for explaining an action pattern corresponding to a lighting state LA1 of a traffic signal in the first embodiment of the present disclosure;

FIG. 8 is a conceptual diagram for explaining an action pattern corresponding to a lighting state LA2 of a traffic signal in the first embodiment of the present disclosure;

FIG. 9 is a conceptual diagram for explaining an action pattern corresponding to a lighting state LB1 of a traffic signal in the first embodiment of the present disclosure;

FIG. 10 is a conceptual diagram for explaining an action pattern corresponding to a lighting state LB2 of a traffic signal in the first embodiment of the present disclosure;

FIG. 11 is a conceptual diagram for explaining an action pattern corresponding to a lighting state LW of a traffic signal in the first embodiment of the present disclosure;

FIG. 12 is a conceptual diagram for explaining an action pattern corresponding to a lighting state LW of a traffic signal in the first embodiment of the present disclosure;

FIG. 13 is a conceptual diagram for explaining an action pattern corresponding to a lighting state LX of a traffic signal in the first embodiment of the present disclosure;

FIG. 14 is a conceptual diagram for explaining an action pattern corresponding to a lighting state LC1 of a traffic signal in the first embodiment of the present disclosure;

FIG. 15 is a conceptual diagram for explaining an action pattern corresponding to a lighting state LC2 of a traffic signal in the first embodiment of the present disclosure;

FIG. 16 is a block diagram showing a functional configuration example of a traffic signal interpretation system according to the first embodiment of the present disclosure;

FIG. 17 is a flow chart showing in summary processing by the traffic signal interpretation system according to the first embodiment of the present disclosure;

FIG. 18 is a block diagram showing a first configuration example of the traffic signal interpretation system according to the first embodiment of the present disclosure;

FIG. 19 is a block diagram showing an example of a sensor group and driving environment information according to the first embodiment of the present disclosure;

FIG. 20 is a block diagram showing a second configuration example of the traffic signal interpretation system according to the first embodiment of the present disclosure;

FIG. 21 is a block diagram showing a functional configuration example of the traffic signal interpretation system according to a second embodiment of the present disclosure;

FIG. 22 is a conceptual diagram for explaining an example of rule information according to the second embodiment of the present disclosure;

FIG. 23 is a flow chart showing processing by the traffic signal interpretation system according to the second embodiment of the present disclosure;

FIG. 24 is a conceptual diagram for explaining a first example of application of the traffic signal interpretation system according to the second embodiment of the present disclosure;

FIG. 25 is a conceptual diagram for explaining the first example of application of the traffic signal interpretation system according to the second embodiment of the present disclosure;

FIG. 26 is a conceptual diagram for explaining the first example of application of the traffic signal interpretation system according to the second embodiment of the present disclosure;

FIG. 27 is a conceptual diagram for explaining a second example of application of the traffic signal interpretation system according to the second embodiment of the present disclosure;

FIG. 28 is a conceptual diagram for explaining the second example of application of the traffic signal interpretation system according to the second embodiment of the present disclosure;

FIG. 29 is a conceptual diagram for explaining the second example of application of the traffic signal interpretation system according to the second embodiment of the present disclosure;

FIG. 30 is a conceptual diagram for explaining an example of the rule information according to a third embodiment of the present disclosure;

FIG. 31 is a conceptual diagram for explaining an example of application of the traffic signal interpretation system according to the third embodiment of the present disclosure;

FIG. 32 is a conceptual diagram for explaining an example of the rule information according to a fourth embodiment of the present disclosure;

FIG. 33 is a conceptual diagram for explaining an example of application of the traffic signal interpretation system according to the fourth embodiment of the present disclosure;

FIG. 34 is a block diagram showing a functional configuration example of the traffic signal interpretation system according to a fifth embodiment of the present disclosure;

FIG. 35 is a conceptual diagram for explaining an example of the rule information according to a fifth embodiment of the present disclosure;

FIG. 36 is a conceptual diagram for explaining another example of the rule information according to the fifth embodiment of the present disclosure;

FIG. 37 is a conceptual diagram for explaining the other example of the rule information according to the fifth embodiment of the present disclosure;

FIG. 38 is a conceptual diagram for explaining the other example of the rule information according to the fifth embodiment of the present disclosure;

FIG. 39 is a block diagram showing a functional configuration example of the traffic signal interpretation system according to a sixth embodiment of the present disclosure;

FIG. 40 is a flow chart showing processing by the traffic signal interpretation system according to the sixth embodiment of the present disclosure;

FIG. 41 is a conceptual diagram for explaining a first example of application of the traffic signal interpretation system according to the sixth embodiment of the present disclosure;

FIG. 42 is a conceptual diagram for explaining a second example of application of the traffic signal interpretation system according to the sixth embodiment of the present disclosure;

FIG. 43 is a conceptual diagram for explaining a third example of application of the traffic signal interpretation system according to the sixth embodiment of the present disclosure;

FIG. 44 is a conceptual diagram for explaining a fourth example of application of the traffic signal interpretation system according to the sixth embodiment of the present disclosure; and

FIG. 45 is a conceptual diagram for explaining a fifth example of application of the traffic signal interpretation system according to the sixth embodiment of the present disclosure.

### EMBODIMENTS

Embodiments of the present disclosure will be described below with reference to the attached drawings.

### 1. First Embodiment

### 1-1. Traffic Signal Interpretation System

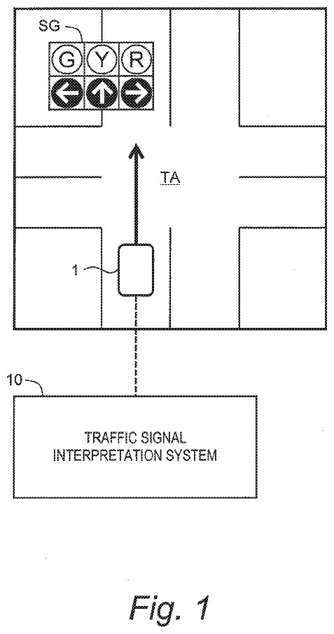

FIG. 1 is a conceptual diagram for explaining an outline of a first embodiment. A traffic signal SG (traffic light) is installed ahead of a vehicle 1. The vehicle 1 travels in accordance with a lighting state (signal indication) of the traffic signal SG. An area where the vehicle 1 should travel in consideration of the lighting state of the traffic signal SG is hereinafter referred to as a “target area TA.” That is, the target area TA is an area where the traffic signal SG is installed and which is subject to the lighting state of the traffic signal SG. The target area TA is exemplified by an intersection and its surroundings, a railroad crossing and its surroundings, a pedestrian crossing and its surroundings, and the like.

There are various patterns of a vehicle action with respect to the target area TA where the traffic signal SG is installed. Such the pattern of the vehicle action is hereinafter referred to as an “action pattern.” It can also be said that the action pattern is a potential vehicle action or a vehicle action candidate.

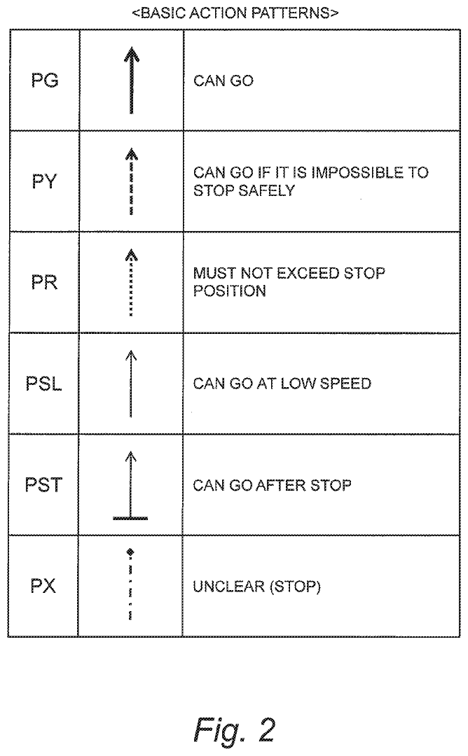

FIG. 2 is a conceptual diagram showing examples of basic action patterns. A content of each action pattern is as follows.

[action pattern PG] can go

[action pattern PY] can go if it is impossible to stop safely

[action pattern PR] must not exceed a stop position, or stop before a stop position

[action pattern PSL] can go slowly, that is, can go at a low speed equal to or lower than a certain speed

[action pattern PST] can go after stop

[action pattern PX] unclear (i.e., the lighting state of the traffic signal SG is unclear)

It is important for achieving automated driving of the vehicle 1 not only to recognize the lighting state of the traffic signal SG but also to interpret a meaning of the recognized lighting state to set an appropriate action pattern corresponding to the recognized lighting state. Such the traffic signal interpretation is performed by a “traffic signal interpretation system 10” according to the present embodiment.

The traffic signal interpretation system 10 is applied to the vehicle 1 executing the automated driving. The traffic signal interpretation system 10 interprets the lighting state of the traffic signal SG and appropriately sets the action pattern with respect to the target area TA where the traffic signal SG is installed. Typically, the traffic signal interpretation system 10 is installed on the vehicle 1. Alternatively, the traffic signal interpretation system 10 may be included in an external device outside the vehicle 1 and remotely set the action pattern. Alternatively, the traffic signal interpretation system 10 may be distributed to the vehicle 1 and the external device. The traffic signal interpretation system 10 may be a part of an automated driving system (vehicle control system) that controls the automated driving of the vehicle 1.

### 1-2. Correspondence Relationship Between Lighting State of Traffic Signal and Action Pattern

In order to interpret the lighting state of the traffic signal SG, a correspondence relationship between the lighting state of the traffic signal SG and the action pattern is defined in advance. Hereinafter, various examples of the correspondence relationship between the lighting state of the traffic signal SG and the action pattern will be described. It should be noted that an overlapping description will be omitted as appropriate.

### <Lighting State LG>

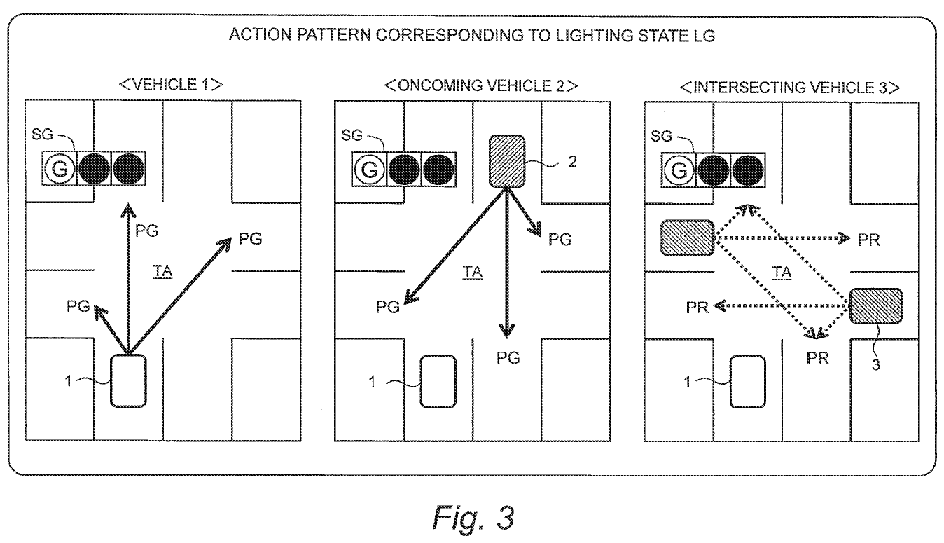

FIG. 3 is a conceptual diagram for explaining the action pattern corresponding to a lighting state LG of the traffic signal SG. The lighting state LG corresponds to a “green light.” That is, a green circular lamp part of the traffic signal SG is lighted.

It should be noted that the lamp part means a part (portion) that is lighted and unlighted in the traffic signal SG. The lamp part is exemplified by a light bulb, an LED (Light Emitting Diode), a luminescent device, a display, and the like. In FIG. 3 and the following description, capital letters “G”, “Y”, and “R” mean green, yellow, and red lamp parts are lighted, respectively.

In the example shown in FIG. 3, the target area TA is an intersection. Since the lighting state LG means the green light, the action pattern of the vehicle 1 in a straight direction is set to the action pattern PG, i.e. “can go.” Similarly, the action patterns of the vehicle 1 in a left-turn direction and a right-turn direction also are set to the action pattern PG. As can be seen from FIG. 3, the action pattern is set for each travel direction of the vehicle 1. An actual action (go straight, turn left, or turn right) of the vehicle 1 is appropriately determined according to a destination, a travel plan, a surrounding situation, and so forth. In that sense, it can be said that the action pattern is a potential vehicle action or a vehicle action candidate.

In the case of the action pattern PG, the vehicle 1 is allowed to enter into the target area TA. In this case, it is desirable to grasp the action pattern of another vehicle that intersects or merges with the action pattern PG of the vehicle 1 for the purpose of travel control, assuring safety of the vehicle 1 and the like. The other vehicle is exemplified by an oncoming vehicle 2 and an intersecting vehicle 3.

An oncoming vehicle 2 may exist in an oncoming lane that is opposite to a subject lane in which the vehicle 1 exists. Typically, when the lighting state of the traffic signal SG for the subject lane is the green light, a lighting state of a traffic signal (not shown) for the oncoming lane also is the green light. Therefore, the action pattern of the oncoming vehicle 2 is set to the action pattern PG for each of the straight direction, the left-turn direction, and the right-turn direction.

An intersecting vehicle 3 may exist in an intersecting lane that intersects the subject lane in which the vehicle 1 exists. Typically, when the lighting state of the traffic signal SG for the subject lane is the green light, a lighting state of a traffic signal (not shown) for the intersecting lane is a red light. Therefore, the action pattern of the intersecting vehicle 3 is set to the action pattern PR for each of the straight direction, the left-turn direction, and the right-turn direction.

As can be seen from FIG. 3, in the target area TA, the action pattern PG of the vehicle 1 and the action pattern PG of the oncoming vehicle 2 intersect or merge with each other. In some embodiments, in order to realize safe vehicle travel, priority of the action pattern PG may be set in advance.

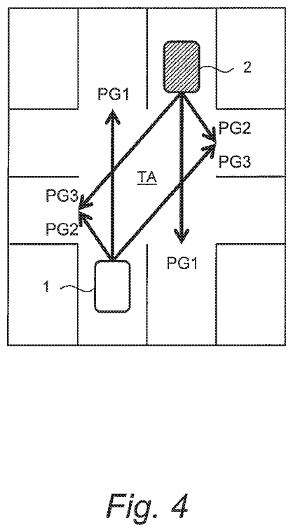

FIG. 4 is a conceptual diagram for explaining the priority of the action pattern PG. A number i (i=1, 2, 3) meaning the priority is added to the reference numeral PG in FIG. 4. The action pattern PG1 has the highest priority and the action pattern PG3 has the lowest priority. For example, the action pattern PG1 of the vehicle 1 in the straight direction gets preference over the action pattern PG3 of the oncoming vehicle 2 in the right-turn direction. As another example, the action pattern PG2 of the oncoming vehicle 2 in the left-turn direction gets preference over the action pattern PG3 of the vehicle 1 in the right-turn direction. The action patterns PGi with the same priority i do not intersect nor merge.

### <Lighting State LY>

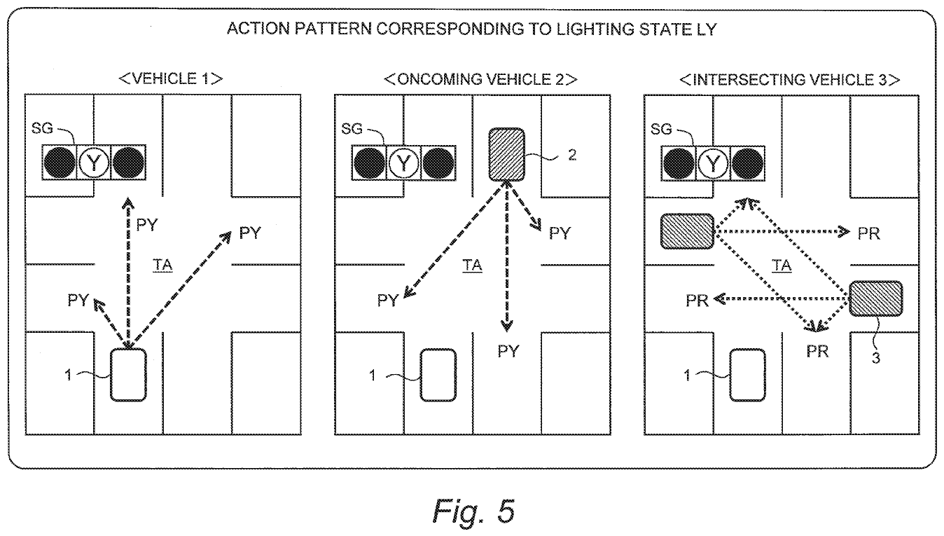

FIG. 5 is a conceptual diagram for explaining the action pattern corresponding to a lighting state LY. The lighting state LY corresponds to a “yellow light.” That is, a yellow circular lamp part of the traffic signal SG is lighted.

The action pattern of the vehicle 1 is set to the action pattern PY for each of the straight direction, the left-turn direction, and the right-turn direction. The action pattern of the oncoming vehicle 2 is set to the action pattern PY for each of the straight direction, the left-turn direction, and the right-turn direction. The action pattern of the intersecting vehicle 3 is set to the action pattern PR for each of the straight direction, the left-turn direction, and the right-turn direction.

It should be noted that the priority of the action pattern PY is the same as in the case of the example shown in FIG. 4.

### <Lighting State LR>

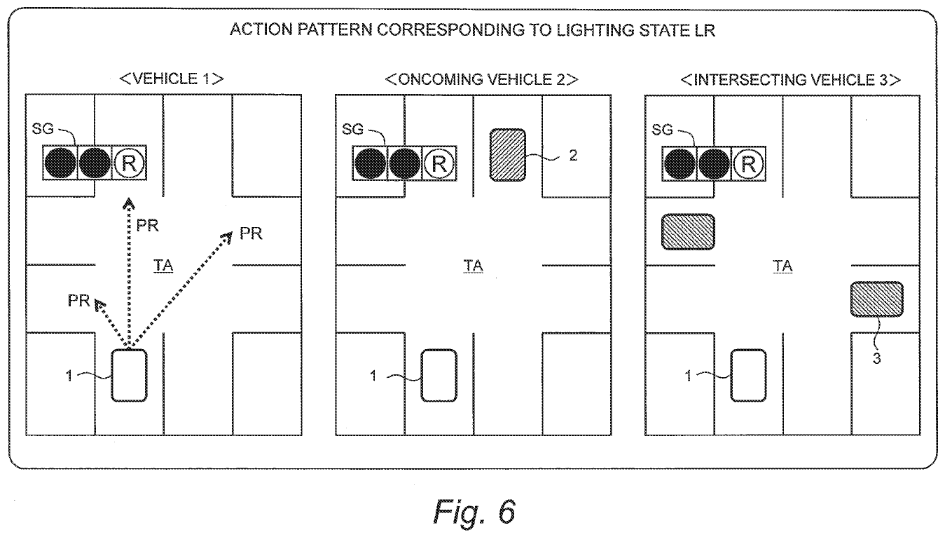

FIG. 6 is a conceptual diagram for explaining the action pattern corresponding to a lighting state LR. The lighting state LR corresponds to a “red light.” That is, a red circular lamp part of the traffic signal SG is lighted.

The action pattern of the vehicle 1 is set to the action pattern PR for each of the straight direction, the left-turn direction, and the right-turn direction.

When the action pattern of the vehicle 1 is the action pattern PR, the action patterns of the oncoming vehicle 2 and the intersecting vehicle 3 may not be set. Alternatively, the action pattern of the oncoming vehicle 2 may be set to the action pattern PR, and the action pattern of the intersecting vehicle 3 may be set to the action pattern PG.

### <Lighting State LA1>

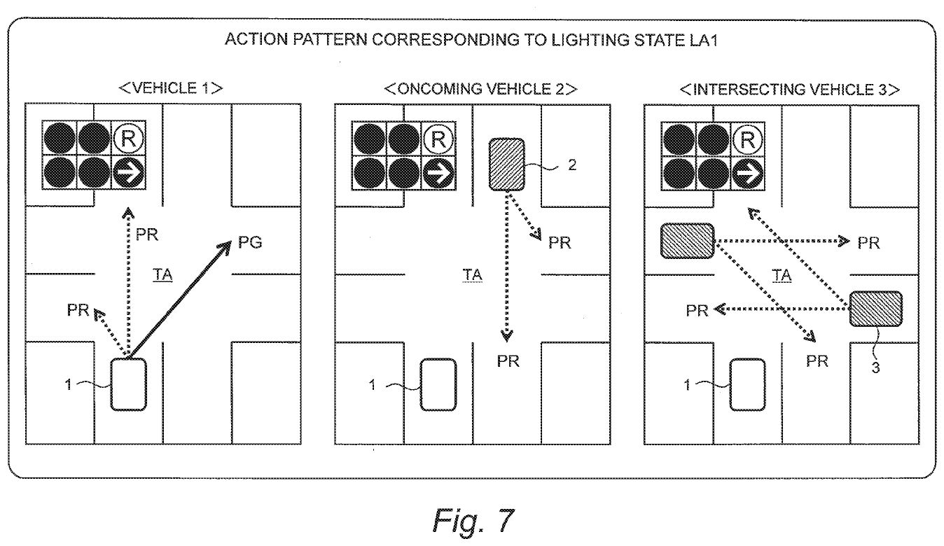

FIG. 7 is a conceptual diagram for explaining the action pattern corresponding to a lighting state LA1. In the lighting state LA1, a right arrow signal permitting right-turn is lighted in addition to the above-described lighting state LR (see FIG. 6).

The action patterns of the vehicle 1 in the straight direction and the left-turn direction are set to the action pattern PR as in the case of the lighting state LR. On the other hand, the action pattern of the vehicle 1 in the right-turn direction is set to the action pattern PG, that is, “can go.” In this manner, the action pattern of the vehicle 1 corresponding to the lighting state LA1 is represented by a combination of a plurality of basic action patterns.

The action pattern of the oncoming vehicle 2 which intersects or merges with the action pattern PG of the vehicle 1 is the action pattern PR. The action pattern of the intersecting vehicle 3 which intersects or merges with the action pattern PG of the vehicle 1 is the action pattern PR.

### <Lighting State LA2>

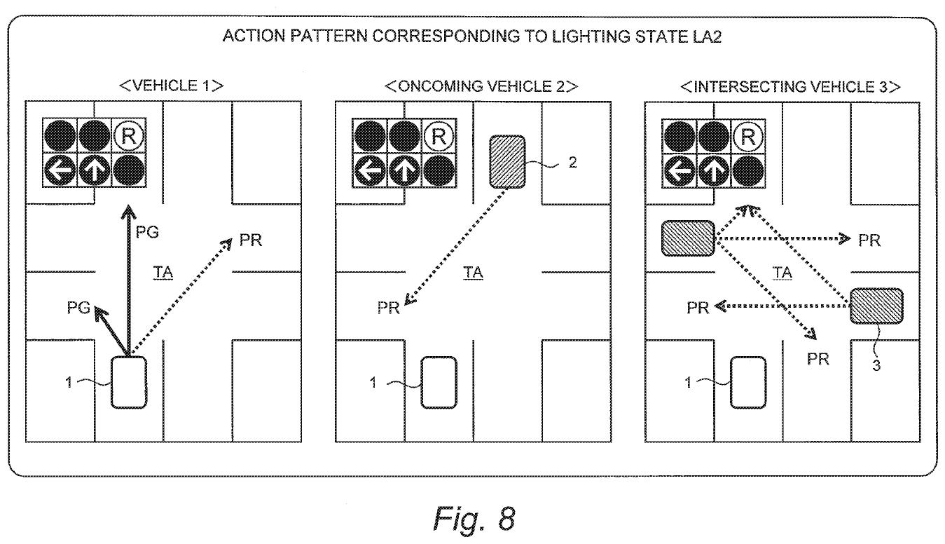

FIG. 8 is a conceptual diagram for explaining the action pattern corresponding to a lighting state LA2. In the lighting state LA2, an up arrow signal permitting going straight and a left arrow signal permitting left-turn are lighted in addition to the above-described lighting state LR (see FIG. 6).

The action pattern of the vehicle 1 in the right-turn direction is set to the action pattern PR as in the case of lighting state LR. On the other hand, the action patterns of the vehicle 1 in the straight direction and the left-turn direction are set to the action pattern PG, that is, “can go.” In this manner, the action pattern of the vehicle 1 corresponding to the lighting state LA2 is represented by a combination of a plurality of basic action patterns.

The action pattern of the oncoming vehicle 2 which intersects or merges with the action pattern PG of the vehicle 1 is the action pattern PR. The action pattern of the intersecting vehicle 3 which intersects or merges with the action pattern PG of the vehicle 1 is the action pattern PR.

### <Lighting State LB1>

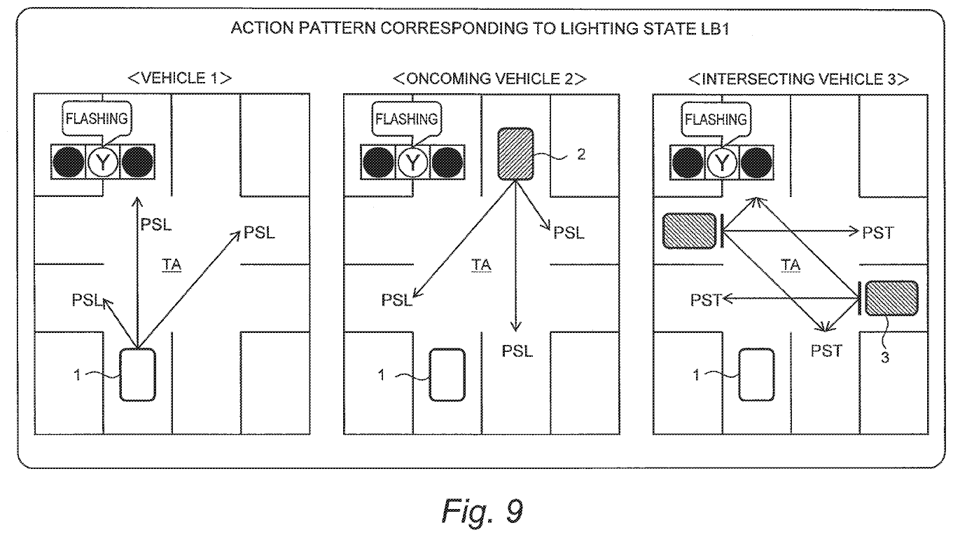

FIG. 9 is a conceptual diagram for explaining the action pattern corresponding to a lighting state LB1. The lighting state LB1 corresponds to a “yellow flashing light.” That is, the yellow circular lamp part of the traffic signal SG is flashing.

The action pattern of the vehicle 1 is set to the action pattern PSL for each of the straight direction, the left-turn direction, and the right-turn direction. The action pattern of the oncoming vehicle 2 is set to the action pattern PSL for each of the straight direction, the left-turn direction, and the right-turn direction. The action pattern of the intersecting vehicle 3 is set to the action pattern PST for each of the straight direction, the left-turn direction, and the right-turn direction.

It should be noted that the priority of the action pattern PSL is the same as in the case of the example shown in FIG. 4. Moreover, the priority of the action pattern PSL is higher than the priority of the action pattern PST.

### <Lighting State LB2>

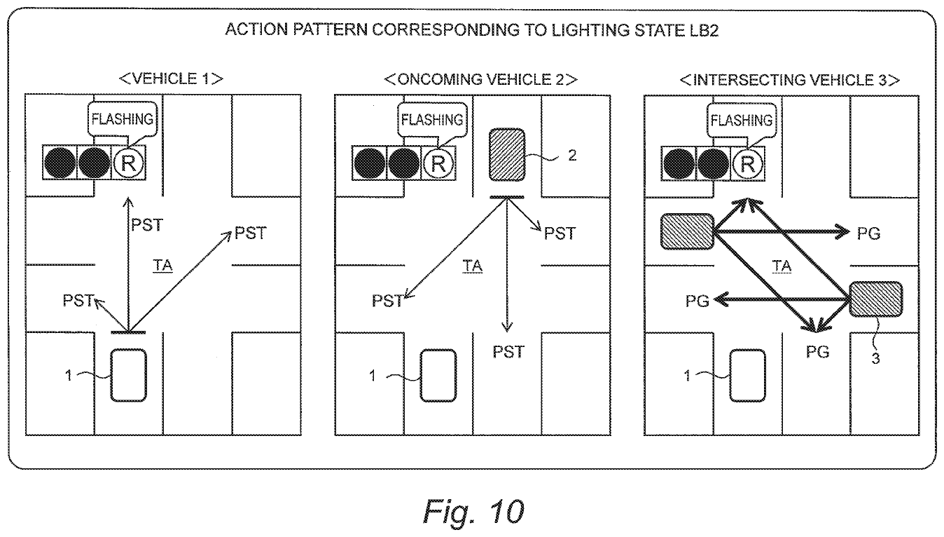

FIG. 10 is a conceptual diagram for explaining the action pattern corresponding to a lighting state LB2. The lighting state LB corresponds to a “red flashing light.” That is, the red circular lamp part of the traffic signal SG is flashing.

The action pattern of the vehicle 1 is set to the action pattern PST for each of the straight direction, the left-turn direction, and the right-turn direction. The action pattern of the oncoming vehicle 2 is set to the action pattern PST for each of the straight direction, the left-turn direction, and the right-turn direction. The action pattern of the intersecting vehicle 3 is set to the action pattern PG (or the action pattern PSL) for each of the straight direction, the left-turn direction, and the right-turn direction.

It should be noted that the priority of the action pattern PST is the same as in the case of the example shown in FIG. 4. Moreover, the priority of the action pattern PST is lower than the priority of the action pattern PG.

### <Lighting State LW>

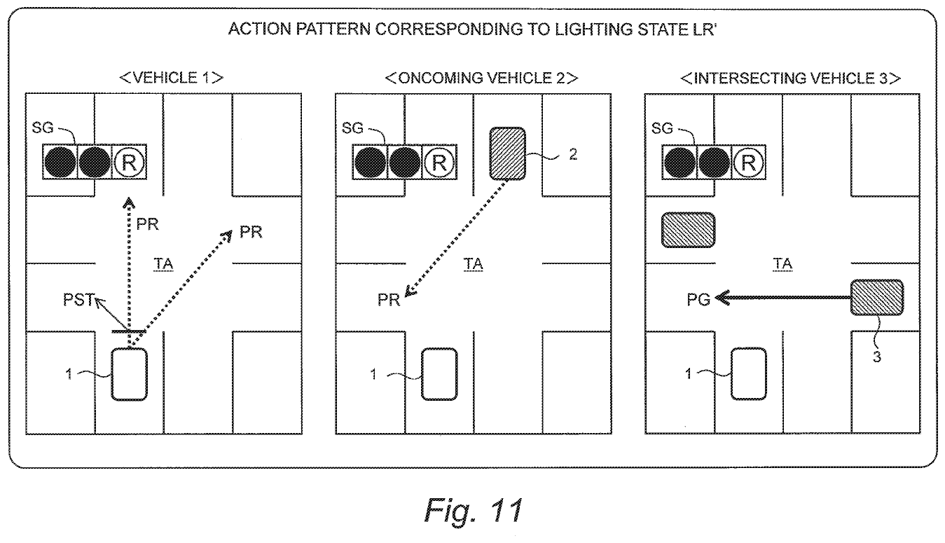

FIG. 11 is a conceptual diagram for explaining the action pattern corresponding to a lighting state LW. The lighting state LW corresponds to the red light including an exception. More specifically, left-turn is permitted as long as it is safe even in the case of the red light. This is equivalent to that “right-turn is permitted as long as it is safe even in the case of the red light” in the United States for example.

The action pattern of the intersecting vehicle 3 is the action pattern PG. The action patterns of the vehicle 1 in the straight direction and the right-turn direction is set to the action pattern PR as in the case of the lighting state LR (see FIG. 6). On the other hand, the action pattern of the vehicle 1 in the left-turn direction is set to the action pattern PST, that is, “can go after stop.” The priority of the action pattern PST is lower than the priority of the action pattern PG.

It should be noted that it is possible to know the exceptional traffic signal SG by utilizing traffic signal map information, for example. The traffic signal map information indicates a “position in the absolute coordinate system” and a “type” of the traffic signal SG which are associated with each other. For example, it is possible to calculate the position in the absolute coordinate system of the traffic signal SG imaged by a camera, based on position information indicating a position of the vehicle 1 and camera imaging information. Then, it is possible to know the type of the traffic signal SG by referring to the traffic signal map information.

### <Lighting State LW>

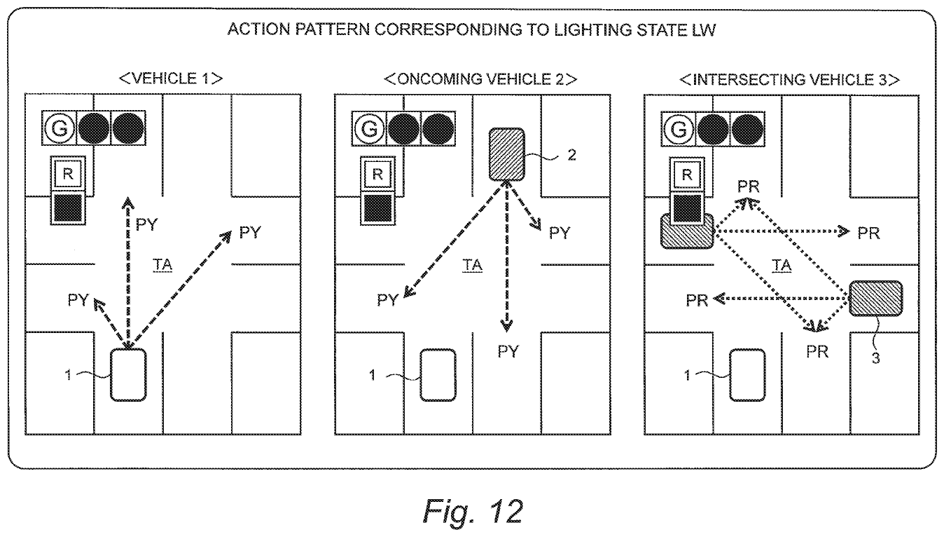

FIG. 12 is a conceptual diagram for explaining the action pattern corresponding to a lighting state LW. The lighting state LW is a combination of the lighting state of a traffic signal for vehicles and the lighting state of a traffic signal for pedestrians. More specifically, the traffic signal for vehicles is green light and the traffic signal for pedestrians is red light. Since the traffic signal for pedestrians is the red light, it is predicted that the traffic signal for vehicles will soon change from the green light to the yellow light. Therefore, each action pattern is set to the same as in the case of the above-described lighting state LY corresponding to the yellow light (see FIG. 5).

### <Lighting State LX>

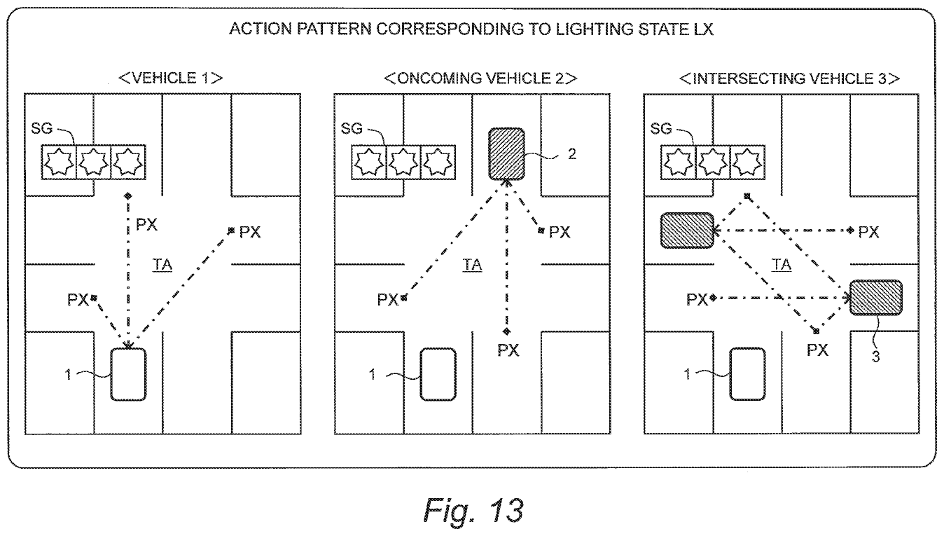

FIG. 13 is a conceptual diagram for explaining the action pattern corresponding to a lighting state LX. The lighting state LX means that the lighting state of the traffic signal SG is unclear (unknown). Examples of the cause for the lighting state LX are as follows.

(a) The lighting state (e.g., color) of the traffic signal SG is not well identified.

(b) The traffic signal SG is hidden by a truck and the like and thus invisible.

(c) The traffic signal SG is not lighted due to failure or power outage.

In the case of the lighting state LX, the action pattern of vehicle 1 is set to the action pattern PX. For example, the action pattern PX is “stop before a stop position” as in the case of the action pattern PR. The action patterns of the oncoming vehicle 2 and the intersecting vehicle 3 also are set to the action pattern PX.

### <Lighting States LC1 and LC2>

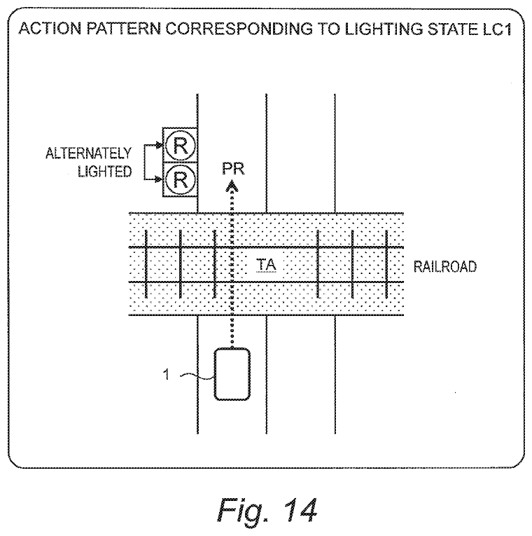

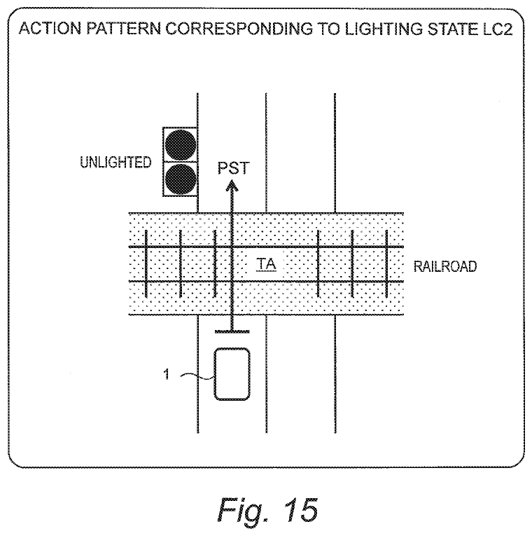

The target area TA where the traffic signal SG is installed is not limited to the intersection. In the examples shown in FIGS. 14 and 15, the target area TA is a railroad crossing of a railroad and its surroundings.

FIG. 14 is a conceptual diagram for explaining the action pattern corresponding to a lighting state LC1. In the lighting state LC1, two red lamp parts are lighted alternately. That is, the lighting state LC1 means “no entry.” The action pattern of the vehicle 1 is set to the action pattern PR.

FIG. 15 is a conceptual diagram for explaining the action pattern corresponding to a lighting state LC2. In the lighting state LC2, both of the two red lamp parts are unlighted. That is, the lighting state LC2 means “entry permitted.” The action pattern of the vehicle 1 is set to the action pattern PST.

### 1-3. Action Pattern Setting Processing

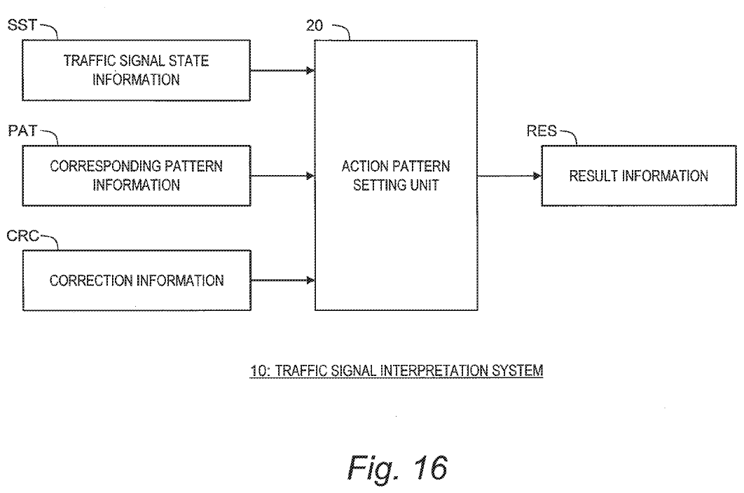

FIG. 16 is a block diagram showing a functional configuration example of the traffic signal interpretation system 10 according to the present embodiment. The traffic signal interpretation system 10 includes an action pattern setting unit 20. The action pattern setting unit 20 at least sets the action pattern of the vehicle 1 with respect to the target area TA where the traffic signal SG is installed. The action pattern setting unit 20 may further set the action patterns of the oncoming vehicle 2 and the intersecting vehicle 3 with respect to the same target area TA (see FIGS. 3, 5, 7, 8, and so forth). Processing that sets the action pattern with respect to the target area TA where the traffic signal SG is installed is hereinafter referred to as “action pattern setting processing.”

According to the present embodiment, the action pattern setting unit 20 executes the action pattern setting processing based on traffic signal state information SST, corresponding pattern information PAT, and correction information CRC.

The traffic signal state information SST indicates the lighting state of the traffic signal SG. As shown in FIGS. 3 to 15, there are various examples of the lighting state of the traffic signal SG. Typically, the lighting state is defined by a combination of “color (green, yellow, red, etc.)” and a “shape (circle, arrow, etc.)” of a lighting part (the lighted lamp part). The lighting state may include whether the lighting part is flashing or not. In some cases, the lighting state is unclear (unknown).

The lighting state of the traffic signal SG is recognized, for example, by using a camera installed on the vehicle 1. The camera images a situation around the vehicle 1. Camera image information includes an image imaged by the camera, that is, an image indicating the situation around the vehicle 1. An image analysis method for detecting (extracting) the traffic signal SG from the image and recognizing the lighting state of the detected traffic signal SG is well-known (see Patent Literature 1 for example). The traffic signal state information SST indicates a result of recognition of the lighting state of the traffic signal SG.

As another example, the traffic signal SG may have a function of distributing its own lighting state. In this case, information delivered from the traffic signal SG is used as the traffic signal state information SST.

The corresponding pattern information PAT indicates the correspondence relationship between the lighting state of the traffic signal SG and the action pattern. The correspondence relationship between the lighting state of the traffic signal SG and the action pattern is as exemplified in FIGS. 3-15. The corresponding pattern information PAT is created in advance.

Referring to the corresponding pattern information PAT makes it possible to acquire the action pattern corresponding to (associated with) the lighting state indicated by the traffic signal state information SST. However, the action pattern obtained based only on the traffic signal state information SST and the corresponding pattern information PAT is not always appropriate.

As an example, let us consider a case where the lighting state of the traffic signal SG changes with time according to a certain repetition pattern. In this case, there is a “context” regarding the lighting state. Even if a lighting state at a certain timing and a lighting state at another timing are seemingly the same, their meanings may differ from each other depending on the context. In the corresponding pattern information PAT, the lighting state and the action pattern merely correspond one-to-one with each other and the context of the lighting state is not taken into consideration. Considering the context of the lighting state of the traffic signal SG can make it possible to more appropriately set the action pattern.

As another example, let us consider a situation where another vehicle still remains in the intersection even after the lighting state of the traffic signal SG changes from the red light to the green light. In this situation, it is not desirable from a viewpoint of safety that the vehicle 1 immediately enters the intersection. That is to say, setting the action pattern based only on the lighting state of the traffic signal SG is not necessarily appropriate. Referring to a behavior of a surrounding vehicle around the vehicle 1 in addition to the lighting state of the traffic signal SG can make it possible to more appropriately set the action pattern.

In view of the above, the action pattern setting unit 20 executes the action pattern setting processing in consideration of not only the traffic signal state information SST and the corresponding pattern information PAT but also the “correction information CRC.” The correction information CRC is information used for further correcting the action pattern obtained based on the traffic signal state information SST and the corresponding pattern information PAT. Various examples of the correction information CRC are considered. The various examples of the correction information CRC will be described in more detail in later embodiments.

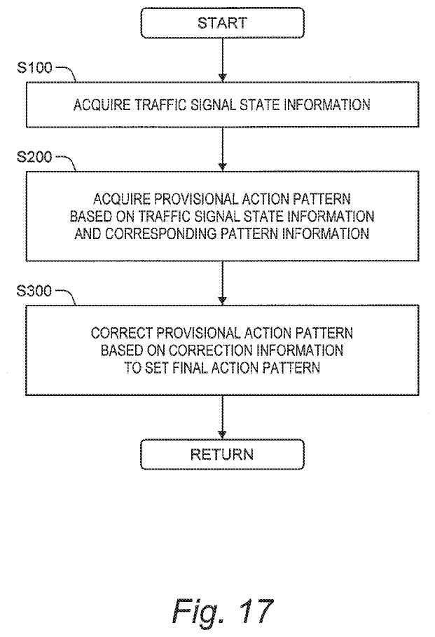

FIG. 17 is a flow chart showing in summary processing by the traffic signal interpretation system 10 according to the present embodiment. The process flow shown in FIG. 17 is repeatedly executed every certain cycle.

In Step S100, the action pattern setting unit 20 acquires the latest traffic signal state information SST.

In Step S200, the action pattern setting unit 20 provisionally acquires the action pattern based on the traffic signal state information SST acquired in Step S100 and the corresponding pattern information PAT created in advance. More specifically, the action pattern setting unit 20 refers to the corresponding pattern information PAT to provisionally acquire the action pattern corresponding to (associated with) the lighting state indicated by the traffic signal state information SST. The action pattern acquired here is hereinafter referred to as a “provisional action pattern.”

In Step S300, the action pattern setting unit 20 sets the final action pattern with respect to the target area TA by appropriately correcting the provisional action pattern based on the correction information CRC. The action pattern with respect to the target area TA includes at least the action pattern of the vehicle 1. The action pattern with respect to the target area TA may further include the action patterns of the oncoming vehicle 2 and the intersecting vehicle 3.

Then, the action pattern setting unit 20 generates and outputs result information RES indicating the final action pattern acquired. The result information RES is utilized for planning of a travel plan of the vehicle 1, travel control of the vehicle 1, and the like.

### 1-4. Configuration Example of Traffic Signal Interpretation System

Hereinafter, a concrete configuration example of the traffic signal interpretation system 10 according to the present embodiment will be described.

### 1-4-1. First Configuration Example

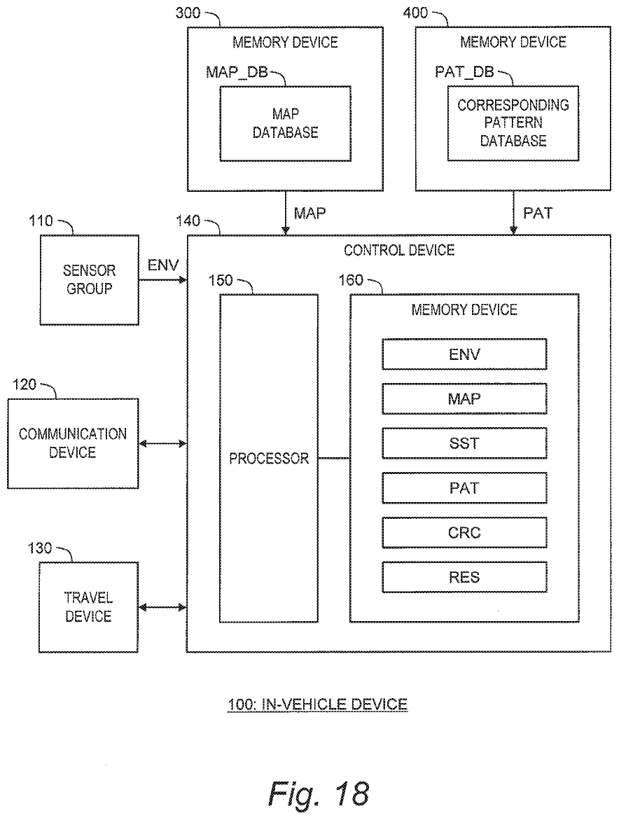

FIG. 18 is a block diagram showing a first configuration example of the traffic signal interpretation system 10 according to the present embodiment. In the first configuration example, the traffic signal interpretation system 10 is realized by an in-vehicle device 100 installed on the vehicle 1.

The in-vehicle device 100 includes a sensor group 110, a communication device 120, a travel device 130, and a control device (controller) 140.

The sensor group 110 acquires driving environment information ENV indicating a driving environment for the vehicle 1.

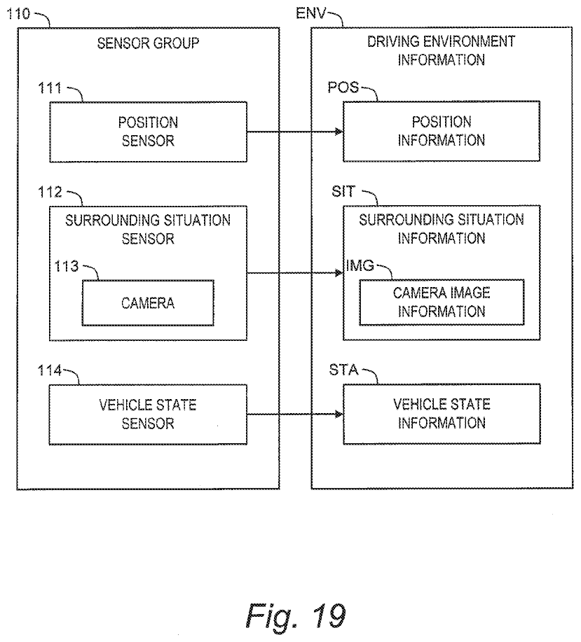

FIG. 19 is a block diagram showing an example of the sensor group 110 and the driving environment information ENV. The sensor group 110 includes a position sensor 111, a surrounding situation sensor 112, and a vehicle state sensor 114. The driving environment information ENV includes position information POS, surrounding situation information SIT, and vehicle state information STA.

The position sensor 111 detects a position and an orientation of the vehicle 1. For example, the position sensor 111 includes a GPS (Global Positioning System) sensor that detects the position and the orientation of the vehicle 1. The position information POS indicates the position and the orientation of the vehicle 1 in the absolute coordinate system.

The surrounding situation sensor 112 detects a situation around the vehicle 1. The surrounding situation sensor 112 includes the camera 113. The camera 113 images a situation around the vehicle 1. Typically, the camera 113 is placed so as to image a situation ahead of the vehicle 1. The surrounding situation sensor 112 may further include a LIDAR (Laser Imaging Detection and Ranging) and/or a radar. The surrounding situation information SIT is information obtained from a result of detection by the surrounding situation sensor 112. The surrounding situation information SIT includes camera image information IMG. The camera image information IMG includes an image imaged by the camera 113, that is, an image indicating the situation around the vehicle 1.

The vehicle state sensor 114 detects a state of the vehicle 1. The state of the vehicle 1 includes a speed (vehicle speed), an acceleration, a steering angle, a yaw rate, and the like of the vehicle 1. In addition, the state of the vehicle 1 includes a driving operation by a driver of the vehicle 1. The driving operation includes an acceleration operation, a braking operation, and a steering operation. The vehicle state information STA indicates the state of the vehicle 1 detected by the vehicle state sensor 114.

The communication device 120 communicates with the outside of the vehicle 1. For example, the communication device 120 communicates with an external device outside the vehicle 1 through a communication network.

The travel device 130 includes a steering device, a driving device, and a braking device. The steering device turns (i.e., changes a direction of) a wheel of the vehicle 1. For example, the steering device includes a power steering (EPS: Electric Power Steering) device. The driving device is a power source that generates a driving force. The driving device is exemplified by an engine and an electric motor. The braking device generates a braking force.

The control device (controller) 140 controls the in-vehicle device 100. The control device 140 is also called an ECU (Electronic Control Unit). The control device 140 includes a processor 150 and a memory device 160. A variety of processing is achieved by the processor 150 executing a control program stored in the memory device 160.

For example, the processor 150 executes information acquisition processing that acquires a variety of information. The variety of information is stored in the memory device 160.

More specifically, the processor 150 acquires the driving environment information ENV from the sensor group 110 and stores the driving environment information ENV in the memory device 160.

Moreover, the processor 150 acquires necessary map information MAP from a map database MAP_DB and stores the map information MAP in the memory device 160. The map database MAP_DB is stored in a memory device 300. The memory device 300 may be a part of the in-vehicle device 100, or may be installed outside the vehicle 1. When the map database MAP_DB is present outside the vehicle 1, the processor 150 accesses the map database MAP_DB through the communication device 120 to acquire necessary map information MAP.

Moreover, the processor 150 acquires the traffic signal state information SST and stores the traffic signal state information SST in the memory device 160. For example, the processor 150 acquires the traffic signal state information SST based on the driving environment information ENV (specifically, the camera image information IMG). More specifically, the processor 150 detects (extracts) the traffic signal SG from the image indicated by the camera image information IMG and recognizing the lighting state of the detected traffic signal SG. Such the image analysis method is well-known (see Patent Literature 1 for example). As another example, when the traffic signal SG has a function of distributing its own lighting state, the processor 150 receives through the communication device 120 the distributed information as the traffic signal state information SST.

Moreover, the processor 150 acquires necessary corresponding pattern information PAT from a corresponding pattern database PAT_DB and stores the corresponding pattern information PAT in the memory device 160. The corresponding pattern database PAT_DB is stored in a memory device 400. The memory device 400 may be a part of the in-vehicle device 100, or may be installed outside the vehicle 1. When the corresponding pattern database PAT_DB is present outside the vehicle 1, the processor 150 accesses the corresponding pattern database PAT_DB through the communication device 120 to acquire necessary corresponding pattern information PAT.

Moreover, the processor 150 acquires the correction information CRC and stores the correction information CRC in the memory device 160. Alternatively, the correction information CRC may be created in advance and stored in the memory device 160. Various examples of the correction information CRC will be described in more detail in later embodiments.

The processor 150 executes the above-described action pattern setting processing based on the traffic signal state information SST, the corresponding pattern information PAT, and the correction information CRC stored in the memory device 160. The processor 150 generates the result information RES indicating the final action pattern acquired and stores the result information RES in the memory device 160.

The processor 150 generates a travel plan of the vehicle 1 during the automated driving based on the result information RES and the driving environment information ENV. For example, the processor 150 acquires the action pattern regarding a target travel direction of the vehicle 1 based on the result information RES. In addition, the processor 150 perceives the situation around the vehicle 1 based on the driving environment information ENV. Then, the processor 150 generates the travel plan for achieving the action pattern (vehicle action) with securing safety. Typically, the travel plan includes a target trajectory that the vehicle 1 is to follow.

Furthermore, the processor 150 executes automated driving control such that the vehicle 1 travels in accordance with the travel plan (the target trajectory). The automated driving control includes at least one of steering control, acceleration control, and deceleration control. The processor 150 executes necessary vehicle travel control among the steering control, the acceleration control, and the deceleration control by appropriately actuating the travel device 130 (i.e., the steering device, the driving device, and the braking device).

The action pattern setting unit 20 shown in FIG. 16 is a functional block of the processor 150. The action pattern setting unit 20 is achieved by the processor 150 executing the control program stored in the memory device 160.

### 1-4-2. Second Configuration Example

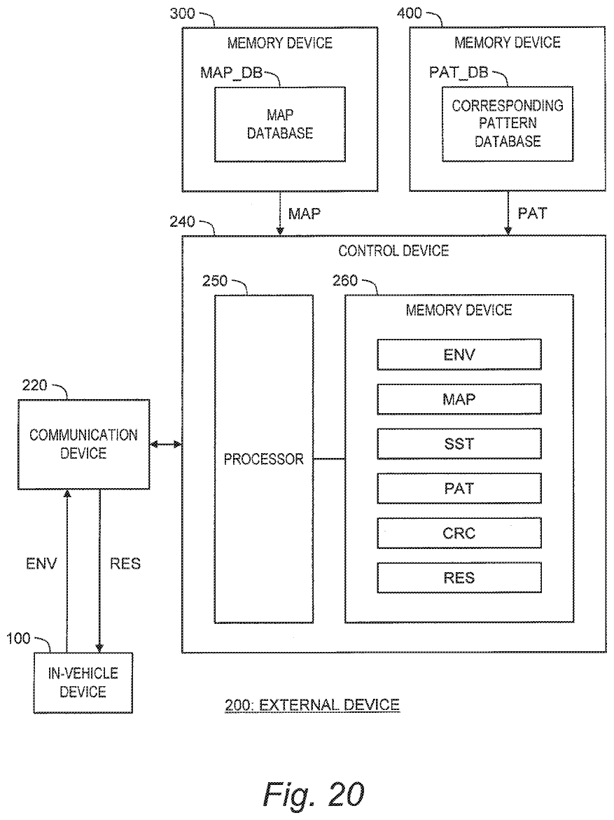

FIG. 20 is a block diagram showing a second configuration example of the traffic signal interpretation system 10 according to the present embodiment. In the second configuration example, the traffic signal interpretation system 10 is realized by an external device 200 outside the vehicle 1. For example, the external device 200 is a management server.

The external device 200 includes a communication device 220 and a control device (controller) 240.

The communication device 220 communicates with the outside of the external device 200. For example, the communication device 220 communicates with the in-vehicle device 100 (see FIG. 18) through a communication network.

The control device (controller) 240 controls the external device 200. The control device 240 includes a processor 250 and a memory device 260. A variety of processing is achieved by the processor 250 executing a control program stored in the memory device 260.

For example, the processor 250 executes information acquisition processing that acquires a variety of information. The variety of information is stored in the memory device 260.

More specifically, the processor 250 acquires the driving environment information ENV from the in-vehicle device 100 through the communication device 220. The driving environment information ENV is stored in the memory device 260.

Moreover, the processor 250 acquires necessary map information MAP from the map database MAP_DB and stores the map information MAP in the memory device 260. The map database MAP_DB is stored in the memory device 300. The memory device 300 may be a part of the external device 200, or may be installed outside the external device 200. When the map database MAP_DB is present outside the external device 200, the processor 250 accesses the map database MAP_DB through the communication device 220 to acquire necessary map information MAP.

Moreover, the processor 250 acquires the traffic signal state information SST and stores the traffic signal state information SST in the memory device 260. A method of acquiring the traffic signal state information SST is the same as in the case of the first configuration example described above.

Moreover, the processor 250 acquires necessary corresponding pattern information PAT from the corresponding pattern database PAT_DB and stores the corresponding pattern information PAT in the memory device 260. The corresponding pattern database PAT_DB is stored in the memory device 400. The memory device 400 may be a part of the external device 200, or may be installed outside the external device 200. When the corresponding pattern database PAT_DB is present outside the external device 200, the processor 250 accesses the corresponding pattern database PAT_DB through the communication device 220 to acquire necessary corresponding pattern information PAT.

Moreover, the processor 250 acquires the correction information CRC and stores the correction information CRC in the memory device 260. Alternatively, the correction information CRC may be created in advance and stored in the memory device 260.

The processor 250 executes the above-described action pattern setting processing based on the traffic signal state information SST, the corresponding pattern information PAT, and the correction information CRC stored in the memory device 260. The processor 250 generates the result information RES indicating the final action pattern acquired and stores the result information RES in the memory device 260.

The processor 250 may provide the result information RES to the in-vehicle device 100 through the communication device 220. The processor 150 of the in-vehicle device 100 generates the travel plan of the vehicle 1 to execute the automated driving control based on the result information RES and the driving environment information ENV.

The action pattern setting unit 20 shown in FIG. 16 is a functional block of the processor 250. The action pattern setting unit 20 is achieved by the processor 250 executing the control program stored in the memory device 260.

### 1-4-3. Third Configuration Example

The functions of the traffic signal interpretation system 10 may be distributed to the processor 150 of the in-vehicle device 100 and the processor 250 of the external device 200. Information necessary for the processing may be distributed to the memory device 160 of the in-vehicle device 100, the memory device 260 of the external device 200, the memory device 300, and the memory device 400. Necessary information is shared by the in-vehicle device 100 and the external device 200 through communication.

The above-described first to third configuration examples can also be summarized as follows. That is, the traffic signal interpretation system 10 includes one processor (i.e., the processor 150 or the processor 250) or a plurality of processors (i.e., the processor 150 and the processor 250). Moreover, the traffic signal interpretation system 10 includes one or more memory devices (i.e., the memory devices 160, 260, 300, 400). The information necessary for the processing by the traffic signal interpretation system 10 is stored in the one or more memory devices. The one or more processors access the one or more memory devices to acquire the necessary information and execute the above-described processing based on the acquired information.

### 1-5. Vehicle Control System

A vehicle control system according to the present embodiment includes the traffic signal interpretation system 10 described above and controls the vehicle 1 based on the action pattern that is set by the traffic signal interpretation system 10. More specifically, one processor (i.e., the processor 150 or the processor 250) or a plurality of processors (i.e., the processor 150 and the processor 250) generate a travel plan of the vehicle 1 during the automated driving based on the action pattern that is set by the traffic signal interpretation system 10. Then, the one or more processors (150, 250) control the vehicle 1 such that the vehicle 1 travels in accordance with the travel plan. The control of the vehicle 1 (i.e., the automated driving control) includes at least one of the steering control, the acceleration control, and the deceleration control. The processor 150 of the in-vehicle device 100 executes necessary vehicle travel control among the steering control, the acceleration control, and the deceleration control by appropriately actuating the travel device 130 (i.e., the steering device, the driving device, and the braking device).

### 1-6. Effects

According to the present embodiment, as described above, the traffic signal interpretation system 10 sets the action pattern of the vehicle 1 with respect to the target area TA where the traffic signal SG is installed, based on the traffic signal state information SST, the corresponding pattern information PAT, and the correction information CRC. More specifically, the traffic signal interpretation system 10 refers to the corresponding pattern information PAT to acquire the action pattern corresponding to the lighting state indicated by the traffic signal state information SST as the provisional action pattern. Furthermore, the traffic signal interpretation system 10 sets the final action pattern by correcting the provisional action pattern based on the correction information CRC.

The action pattern simply set based only on the traffic signal state information SST and the corresponding pattern information PAT is not always appropriate. According to the present embodiment, the action pattern is appropriately corrected by further taking the correction information CRC into consideration, and it is thus possible to more appropriately set the action pattern of the vehicle 1 with respect to the target area TA.

Hereinafter, various examples of the correction information CRC will be described in further detail.

### 2. Second Embodiment

### 2-1. Outline

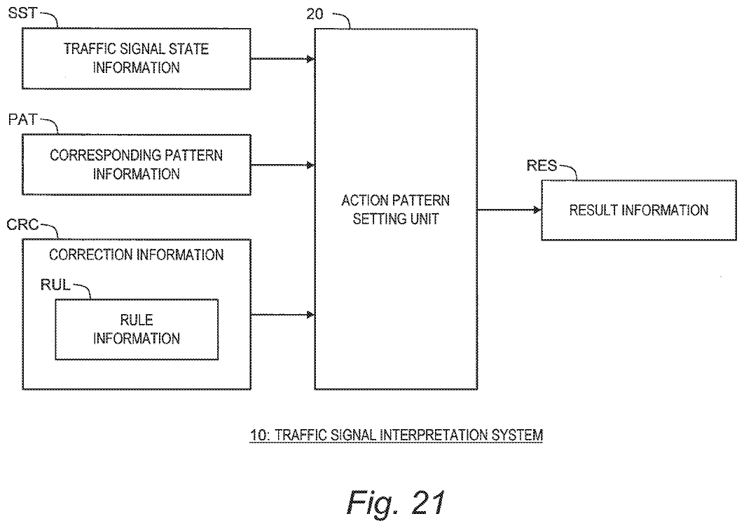

FIG. 21 is a block diagram showing a functional configuration example of the traffic signal interpretation system 10 according to a second embodiment. An overlapping description with the first embodiment will be omitted as appropriate. According to the present embodiment, the correction information CRC includes rule information RUL. The rule information RUL indicates a rule about a “transition (change) of the action pattern.” More specifically, the rule information RUL indicates a rule that permits or prohibits the transition of the action pattern.

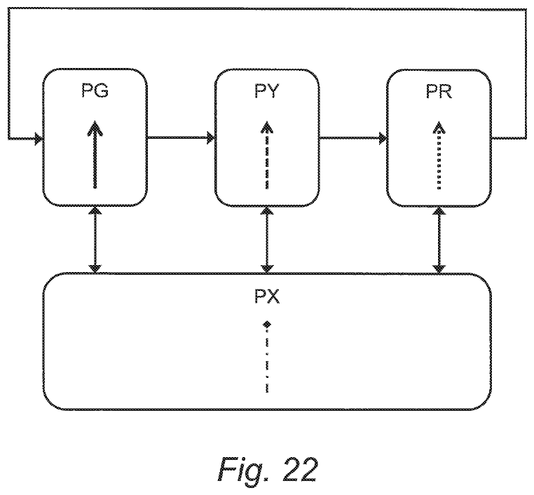

FIG. 22 is a conceptual diagram for explaining an example of the rule information RUL. In the example shown in FIG. 22, the rule information RUL defines a rule about transitions between four action patterns PG, PY, PR, and PX. More specifically, a transition from the action pattern PG to the action pattern PY is permitted, and a transition from the action pattern PY to the action pattern PG is prohibited. A transition from the action pattern PY to the action pattern PR is permitted, and a transition from the action pattern PR to the action pattern PY is prohibited. A transition from the action pattern PR to the action pattern PG is permitted, and a transition from the action pattern PG to the action pattern PR is prohibited. In addition, transitions between the action pattern PX (unclear state) and the other action patterns are permitted.

The rule information RUL is generated in advance and stored in a predetermined memory device (i.e., at least one of the memory devices 160, 260, 300, and 400). The action pattern setting unit 20 acquires the rule information RUL from the predetermined storage device.

When the lighting state indicated by the traffic signal state information SST changes, the action pattern acquired from the corresponding pattern information PAT also transitions. According to the present embodiment, the action pattern setting unit 20 imposes the rule indicated by the rule information RUL on the transition of the action pattern to correct the transition of the action pattern, thereby setting the final action pattern. In other words, the action pattern setting unit 20 sets the final action pattern by correcting the transition of the action pattern so as to be consistent with the rule indicated by the rule information RUL.

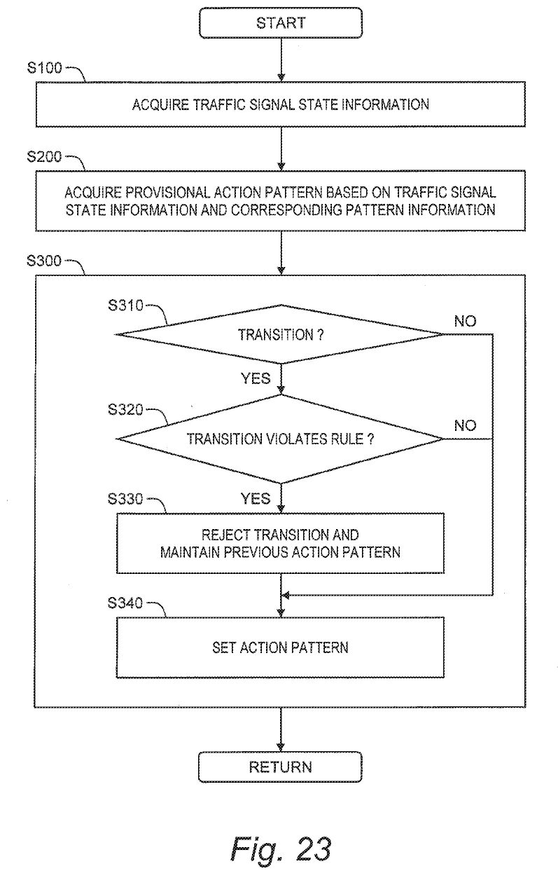

FIG. 23 is a flow chart showing processing by the traffic signal interpretation system 10 according to the present embodiment. Steps S100 and S200 are as described in the foregoing FIG. 17. In Step S100, the action pattern setting unit 20 acquires the latest traffic signal state information SST. In Step S200, the action pattern setting unit 20 refers to the corresponding pattern information PAT to acquire the action pattern corresponding to the lighting state indicated by the traffic signal state information SST as a provisional action pattern. Step S300 (action pattern correcting processing) includes the following processing.

In Step S310, the action pattern setting unit 20 determines whether or not the provisional action pattern becomes (transitions to) an action pattern different from a previous action pattern. Typically, when the lighting state of the traffic signal SG changes, the provisional action pattern becomes (transitions to) one different from the previous action pattern. When the provisional action pattern becomes one different from the previous action pattern (Step S310; Yes), the processing proceeds to Step S320. Otherwise (Step S310; No), the processing proceeds to Step S340.

In Step S320, the action pattern setting unit 20 determines whether the transition from the previous action pattern to the provisional action pattern follows or violates the rule indicated by the rule information RUL. When the transition from the previous action pattern to the provisional action pattern follows the rule (Step S320; No), the processing proceeds to Step S340. On the other hand, when the transition from the previous action pattern to the provisional action pattern violates the rule (Step S320; Yes), the processing proceeds to Step S330.

In Step S330, the action pattern setting unit 20 rejects the transition from the previous action pattern to the provisional action pattern and maintains the previous action pattern as a current action pattern. After that, the processing proceeds to Step S340.

In Step S340, the action pattern setting unit 20 definitely sets the current action pattern (i.e., the final action pattern). When the provisional action pattern does not become one different from the previous action pattern (Step S310; No), the provisional action pattern is set as the current action pattern. When the transition from the previous action pattern to the provisional action pattern follows the rule (Step S320; No), the provisional action pattern is set as the current action pattern. When the transition from the previous action pattern to the provisional action pattern violates the rule (Step S320; Yes), the current action pattern is maintained at the previous action pattern.

### 2-2. Examples of Application

Hereinafter, examples of application of the traffic signal interpretation system 10 according to the present embodiment will be described.

### 2-2-1. First Example of Application

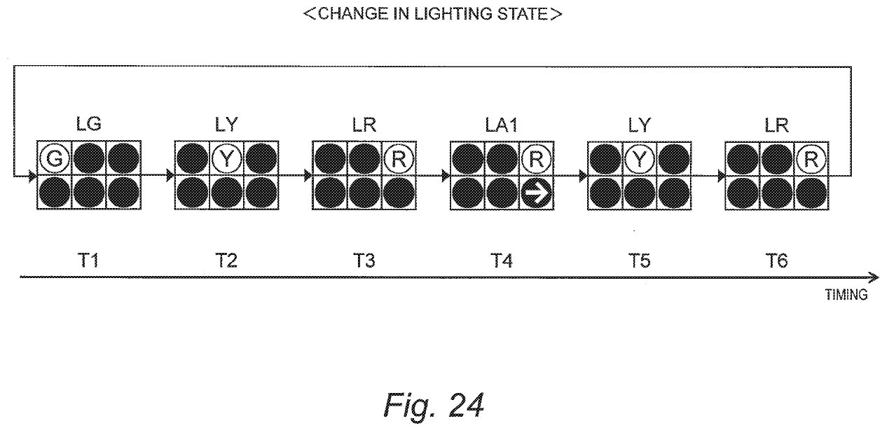

FIGS. 24 to 26 are conceptual diagrams for explaining a first example of application.

FIG. 24 shows an example of a repetition pattern of the lighting state of the traffic signal SG. The lighting state of the traffic signal SG repeatedly changes in an order of LG (green light), LY (yellow light), LR (red light), LA1 (red light+right arrow signal), LY (yellow light), and LR (red light). The lighting states at timings T1, T2, T3, T4, T5, and T6 are LG, LY, LR, LA1, LY, and LR, respectively.

The lighting states at the timing T2 and the timing T5 both are the lighting state LY (yellow light). However, the two lighting states LY are different in “context.” The lighting state LY at the timing T2 is one following the lighting state LG (green light). On the other hand, the lighting state LY at the timing T5 is one following the lighting state LA1 (red light+right arrow signal). Therefore, an appropriate action pattern should differ between the timing T2 and the timing T5.

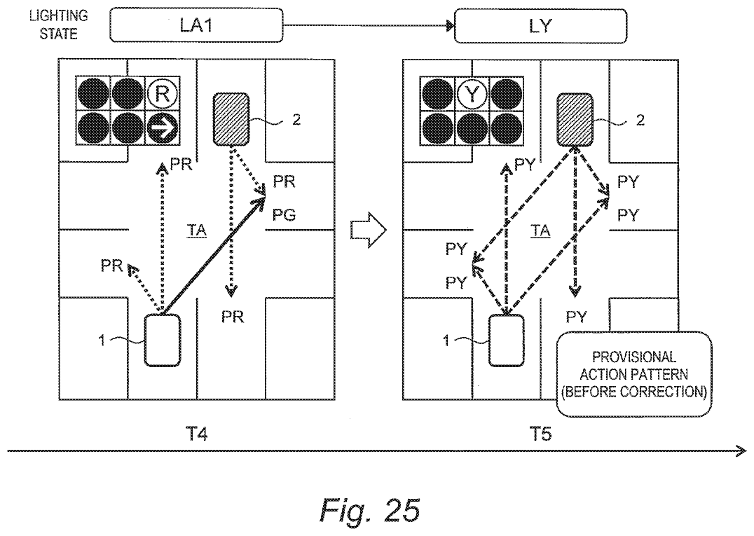

FIG. 25 shows the action pattern at the timing T4 and the provisional action pattern at the timing T5. With respect to the lighting state LA1 at the timing T4, the action pattern of the vehicle 1 in the right-turn direction is the action pattern PG, and the action patterns of the vehicle 1 in the straight direction and the left-turn direction are the action pattern PR (see FIG. 7). With respect to the lighting state LY at the timing T5, the provisional action pattern of the vehicle 1 in each direction is the action pattern PY (see FIG. 5).

However, it is inappropriate that the action patterns of the vehicle 1 in the straight direction and in the left-turn direction directly return from the action pattern PR to the action pattern PY after the lighting state LA1. Therefore, the transition from the action pattern at the timing T4 to the provisional action pattern at the timing T5 is corrected so as to be consistent with the rule shown in FIG. 22.

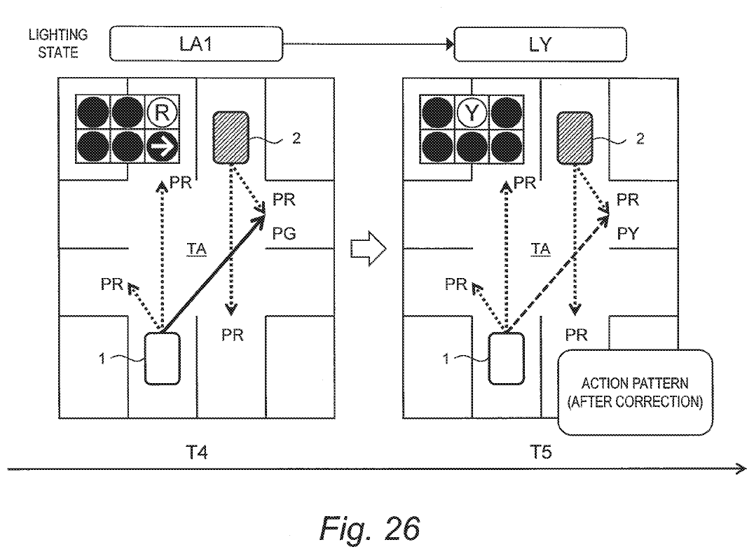

FIG. 26 shows the action pattern after the correction. The transition from the action pattern PR to the action pattern PY is rejected because it violates the rule. As a result, with respect to the lighting state LY at the timing T5, the action patterns of the vehicle 1 in the straight direction and the left-turn direction are maintained at the pre-transition action pattern PR. On the other hand, the transition from the action pattern PG to the action pattern PY follows the rule, and thus the action pattern of the vehicle 1 in the right-turn direction is updated to the action pattern PY. The action pattern after the correction thus obtained is an appropriate one that is consistent with the context of the lighting state of the traffic signal SG.

### 2-2-2. Second Example of Application

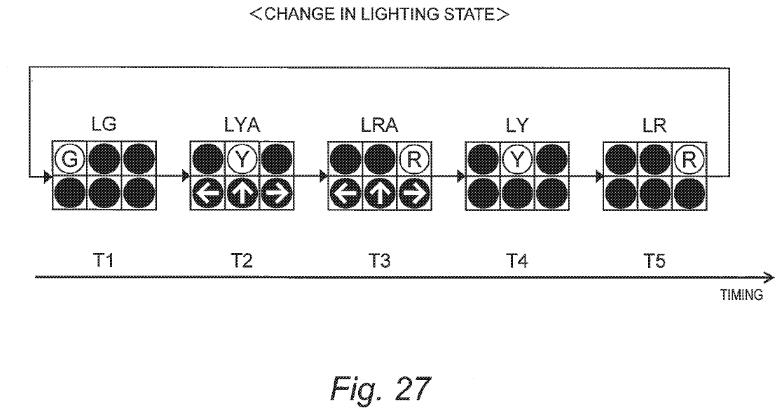

FIGS. 27 to 29 are conceptual diagrams for explaining a second example of application.

FIG. 27 shows an example of a repetition pattern of the lighting state of the traffic signal SG. The lighting state of the traffic signal SG repeatedly changes in an order of LG (green light), LYA (yellow light+omnidirectional arrow signal), LRA (red light+omnidirectional arrow signal), LY (yellow light), and LR (red light). The lighting states at timings T1, T2, T3, T4, and T5 are LG, LYA, LRA, LY, and LR, respectively. It should be noted that the lighting states LYA and LRA are used for generating a time difference from a yellow light and a red light for the oncoming lane.

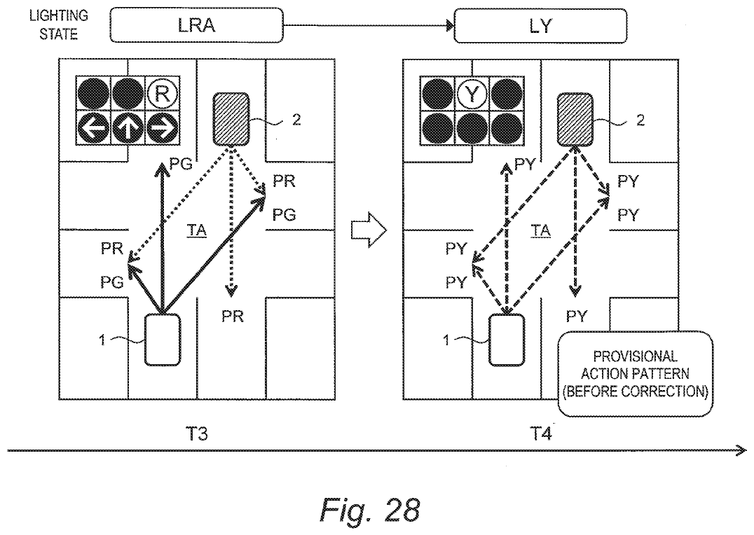

FIG. 28 shows the action pattern at the timing T3 and the provisional action pattern at the timing T4. With respect to the lighting state LRA at the timing T3, the action pattern of the vehicle 1 is the action pattern PG and the action pattern of the oncoming vehicle 2 is the action pattern PR. In other words, the vehicle 1 is allowed to enter the target area TA, but it is not allowed for the oncoming vehicle 2 to enter the target area TA. With respect to the lighting state LY at the timing T4, the provisional action pattern of vehicle 1 is the action pattern PY and the provisional action pattern of the oncoming vehicle 2 is the action pattern PY (see FIG. 5).

However, it is inappropriate that the action pattern of the oncoming vehicle 2 directly returns from the action pattern PR to the action pattern PY after the lighting state LRA. Therefore, the transition from the action pattern at the timing T3 to the provisional action pattern at the timing T4 is corrected so as to be consistent with the rule shown in FIG. 22.

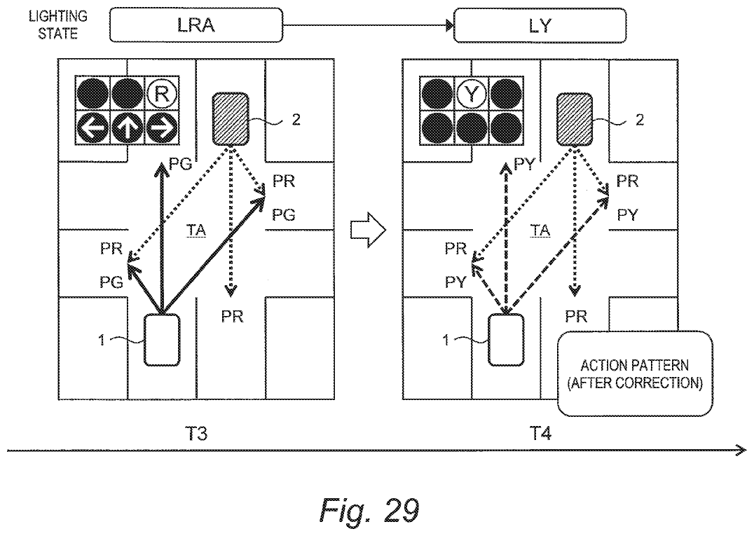

FIG. 29 shows the action pattern after the correction. The transition from the action pattern PR to the action pattern PY is rejected because it violates the rule. As a result, with respect to the lighting state LY at the timing T4, the action pattern of the oncoming vehicle 2 is maintained at the action pattern PR. On the other hand, the transition from action pattern PG to the action pattern PY follows the rule, and thus the action pattern of vehicle 1 is updated to the action pattern PY. The action pattern after the correction thus obtained is an appropriate one that is consistent with the context of the lighting state of the traffic signal SG.

The rule information RUL and the action pattern setting processing in the present embodiment are generalized as follows. The lighting state of the traffic signal SG includes a first lighting state and a second lighting state. The action pattern corresponding to (associated with) the first lighting state in the corresponding pattern information PAT includes a first action pattern. The action pattern corresponding to (associated with) the second lighting state in the corresponding pattern information PAT includes a second action pattern. The rule indicated by the rule information RUL includes prohibiting a transition from the first action pattern to the second action pattern. When the lighting state changes from the first lighting state to the second lighting state, the action pattern setting unit 20 rejects the transition from the first action pattern to the second action pattern and maintain the first action pattern.

### 2-3. Effects

According to the present embodiment, as described above, the correction information CRC includes the rule information RUL indicating the rule that permits or prohibits the transition of the action pattern. The traffic signal interpretation system 10 sets the current action pattern by correcting the transition from the previous action pattern to the provisional action pattern so as to be consistent with the rule indicated by the rule information RUL. It is thus possible to more appropriately set the action pattern with respect to the target area TA.

More specifically, when the transition from the previous action pattern to the provisional action pattern follows the rule, the provisional action pattern is set as the current action pattern. On the other hand, when the transition from the previous action pattern to the provisional action pattern violates the rule, the transition is rejected and the previous action pattern is maintained as the current action pattern. Since the action pattern transition violating the rule is rejected, it is possible to more appropriately set the action pattern.

There is a possibility of occurrence of false recognition of the lighting state of the traffic signal SG. In this case, the lighting state indicated by the traffic signal state information SST is incorrect. When the lighting state indicated by the traffic signal state information SST is incorrect, the action pattern also transitions erroneously. However, the erroneous transition of the action pattern is likely to violate the rule, and thus it is expected that the erroneous transition is rejected. In other words, even when the false recognition of the lighting state of the traffic signal SG occurs, it is suppressed that the false recognition affects the action pattern.

In some embodiments, the rule indicated by the rule information RUL is set in advance such that the transition of the action pattern is consistent with the context of the lighting state of the traffic signal SG. As a result, it is possible to set an appropriate action pattern that is consistent with the context of the lighting state of the traffic signal SG.

Moreover, according to the present embodiment, it is not always necessary to store in advance the repetition pattern of the lighting state for each traffic signal SG. As described in the above examples of application, combining the corresponding pattern information PAT and the rule information RUL makes it possible to deal with various repetition patterns of the lighting state. Although a huge amount of effort and cost is required to generate a database indicating the repetition pattern of the lighting state for each traffic signal SG, such the effort and cost are reduced according to the present embodiment.

### 3. Third Embodiment

A third embodiment is a modification example of the second embodiment. The false recognition of the lighting state of the traffic signal SG may be caused by flicker or pseudo-lighting. In some cases, the false recognition of the lighting state ends after a short period of time and normal recognition is immediately recovered. The third embodiment provides the rule information RUL that enables flexibly reacting to such the short false recognition as well. An overlapping description with the foregoing embodiments will be omitted as appropriate.

### 3-1. Rule Information

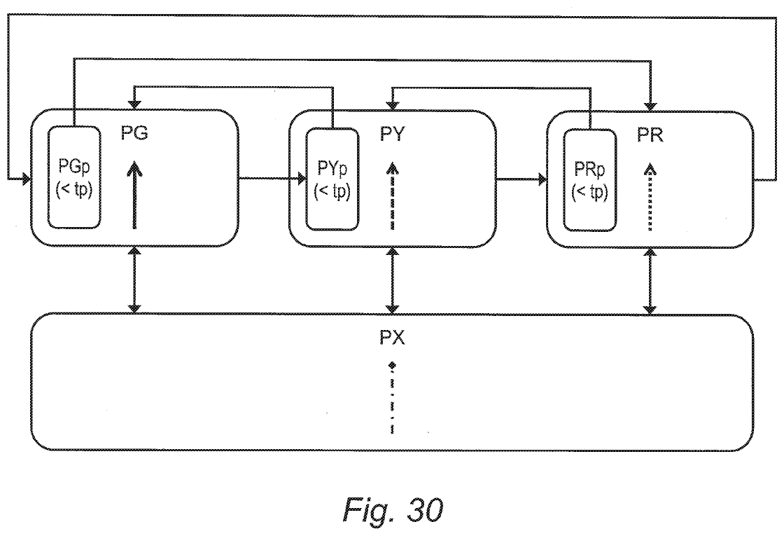

FIG. 30 is a conceptual diagram for explaining an example of the rule information RUL according to the present embodiment. Basically, the transition from the action pattern PG to the action pattern PY is permitted and the transition from the action pattern PY to the action pattern PG is prohibited, as in the case of the second embodiment (see FIG. 22).

However, according to the present embodiment, a “temporary permission time tp” for temporarily permitting the transition from the action pattern PY to the action pattern PG is set. More specifically, the transition (i.e., return) from the action pattern PY to the action pattern PG is permitted until the temporary permission time tp elapses after the transition from the action pattern PG to the action pattern PY. After the temporary permission time tp elapses after the transition from the action pattern PG to the action pattern PY, the transition from the action pattern PY to the action pattern PG is prohibited.

When describing from another point of view, the action pattern PY includes a preliminary action pattern PYp that can return to the action pattern PG. When the transition from the action pattern PG to the action pattern PY occurs, the action pattern is first set to the preliminary action pattern PYp. A transition (i.e., return) from the preliminary action pattern PYp to the action pattern PG is permitted during the temporary permission time tp. After the temporary permission time tp elapses, the action pattern becomes the action pattern PY, and the transition to the action pattern PG is prohibited.

Similarly, a temporary permission time tp and a preliminary action pattern PRp are set with regard to the action pattern PR. Similarly, a temporary permission time tp and a preliminary action pattern PGp are set with regard to the action pattern PG.

It should be noted that the temporary permission time tp is much shorter than a duration in which the same lighting state continues.

### 3-2. Example of Application

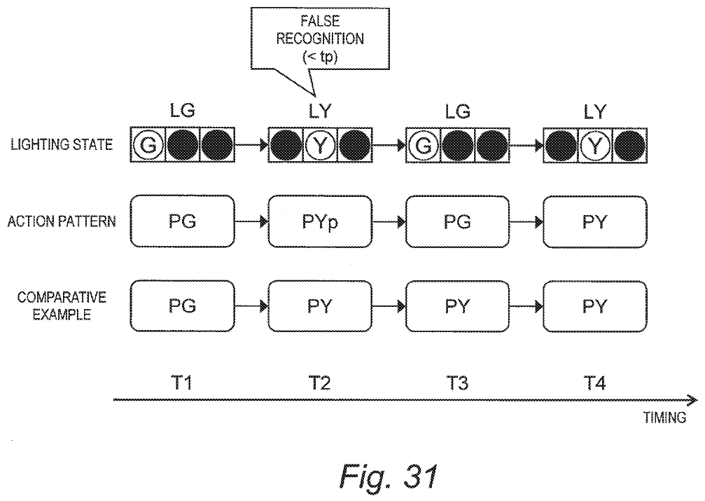

FIG. 31 is a conceptual diagram for explaining an example of application of the traffic signal interpretation system 10 according to the present embodiment. The lighting state of the traffic signal SG at a timing T1 is the lighting state LG (green light). At a timing T2 thereafter, the lighting state is falsely recognized as the lighting state LY (yellow light). However, a duration of the false recognition is less than the temporary permissible time tp. At a timing T3, the lighting state returns to the lighting state LG (green light). At a timing T4, the lighting state becomes the lighting state LY (yellow light).

The lighting states at the timing T2 and the timing T4 both are the lighting state LY (yellow light). However, the two lighting states LY are different in “context.” Although the lighting state LY at the timing T4 is a correct one, the lighting state LY at the timing T2 is due to the short false recognition. In order to flexibly react to such the short false recognition as well, the rule information RUL shown in FIG. 30 is applied.

The action pattern when the rule information RUL shown in FIG. 30 is applied is as follows. The action pattern corresponding to the lighting state LG at the timing T1 is the action pattern PG. The action pattern corresponding to the lighting state LY at the timing T2 is the preliminary action pattern PYp. The action pattern corresponding to the lighting state LG at the timing T3 is the action pattern PG. Note that the transition from the preliminary action pattern PYp to the action pattern PG is permitted according to the rule information RUL shown in FIG. 30.

As a comparative example, let us consider a case where the rule information RUL shown in FIG. 22 is applied. In the case of the comparative example, the preliminary action pattern PYp is not defined, and the transition from the action pattern PY to the action pattern PG is uniformly prohibited. Therefore, the action pattern corresponding to the lighting state LG at the timing T3 is maintained at the action pattern PY. In other words, even though the lighting state is the lighting state LG (green light), the action pattern results in the action pattern PY corresponding to the yellow light. This is inappropriate. According to the present embodiment, on the other hand, the action pattern results in the appropriate action pattern PG corresponding to the green light.

The rule information RUL and the action pattern setting processing in the present embodiment are generalized as follows. The lighting state of the traffic signal SG includes a third lighting state and a fourth lighting state. The action pattern corresponding to (associated with) the third lighting state in the corresponding pattern information PAT includes a third action pattern. The action pattern corresponding to (associated with) the fourth lighting state in the corresponding pattern information PAT includes a fourth action pattern. The rule indicated by the rule information RUL includes: permitting a transition from the third action pattern to the fourth action pattern; permitting a transition from the fourth action pattern to the third action pattern for the temporary permission time tp; and prohibiting the transition from the fourth action pattern to the third action pattern after an elapse of the temporary permission time tp. When the lighting state changes from the third lighting state to the fourth lighting state, the action pattern setting unit 20 executes the transition from the third action pattern to the fourth action pattern. When the lighting state directly returns from the fourth lighting state to the third lighting state before the temporary permission time tp elapses after the lighting state changes from the third lighting state to the fourth lighting state, the action pattern setting unit 20 executes the transition from the fourth action pattern to the third action pattern. When the lighting state directly returns from the fourth lighting state to the third lighting state after the temporary permission time tp elapses after the lighting state changes from the third lighting state to the fourth lighting state, the action pattern setting unit 20 rejects the transition from the fourth action pattern to the third action pattern and maintains the fourth action pattern.

### 3-3. Effects

According to the present embodiment, the temporary permission time tp for temporarily permitting an action pattern transition basically prohibited is set. As a result, even when the false recognition of the lighting state of the traffic signal SG occurs only for a short period time, it is possible to appropriately set the action pattern. According to the present embodiment, it can be said that the appropriate action pattern is set in consideration of the context such as the short false recognition.

### 4. Fourth Embodiment

A fourth embodiment is a modification example of the second embodiment. In some cases, the lighting state of the traffic signal SG becomes the unclear lighting state LX for only a short period of time and then recovers immediately. The fourth embodiment provides the rule information RUL that enables flexibly reacting to such the cases as well. An overlapping description with the foregoing embodiments will be omitted as appropriate.

### 4-1. Rule Information

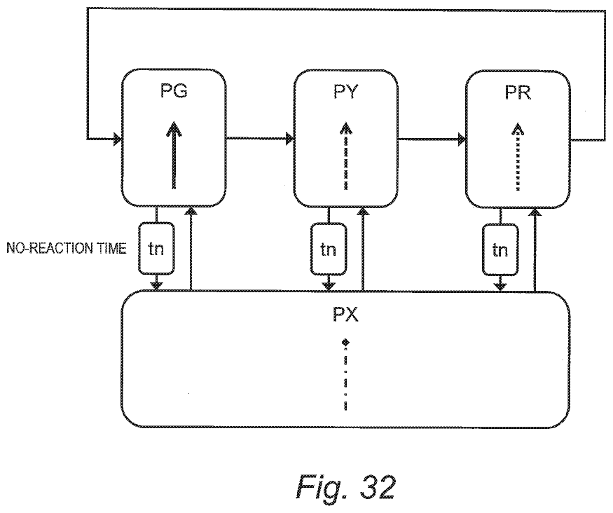

FIG. 32 is a conceptual diagram for explaining an example of the rule information RUL according to the present embodiment. According to the present embodiment, a “no-reaction time tn” is defined with regard to a transition to the action pattern PX (see FIG. 13) corresponding to the unclear lighting state LX. During the no-reaction time tn, the action pattern is maintained as it is without transitioning to the action pattern PX. In other words, the action pattern is prohibited from transitioning to the action pattern PX until the no-reaction time tn elapses after the lighting state of the traffic signal SG changes to the unclear lighting state LX. After the no-reaction time tn elapses after the lighting state of the traffic signal SG changes to the unclear lighting state LX, the action pattern transitions to the action pattern PX.

It should be noted that the no-reaction time tn is much shorter than a duration in which the same lighting state continues.

### 4-2. Example of Application

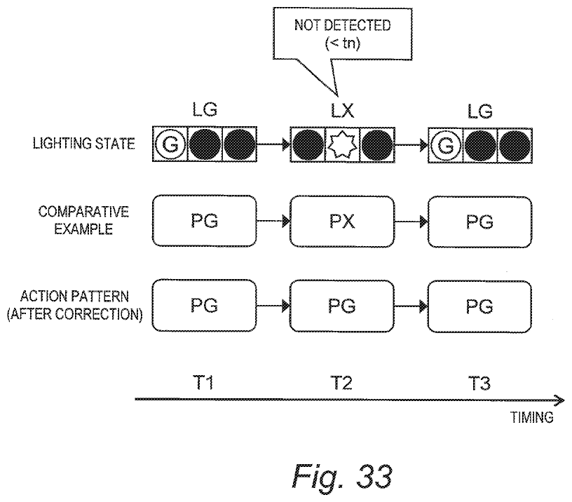

FIG. 33 is a conceptual diagram for explaining an example of application of the traffic signal interpretation system 10 according to the present embodiment. The lighting state of the traffic signal SG at a timing T1 is the lighting state LG (green light). At a timing T2 thereafter, the lighting state becomes the unclear lighting state LX. However, a duration of the lighting state LX is less than the no-reaction time tn. At a timing T3, the lighting state returns to the lighting state LG (green light).

The action pattern at the timing T1 is the action pattern PG. The provisional action pattern corresponding to the lighting state LX at the timing T2 is the action pattern PX. However, the transition from the action pattern PG to the provisional action pattern PX is prohibited during the no-reaction time tn according to the rule information RUL shown in FIG. 32. As a result, the action pattern is maintained at the previous action pattern PG without transitioning to the action pattern PX.

The rule information RUL and the action pattern setting processing in the present embodiment are generalized as follows. The lighting state of the traffic signal SG includes a fifth lighting state and a sixth lighting state (the lighting state LX) meaning unclear. The action pattern corresponding to (associated with) the fifth lighting state in the corresponding pattern information PAT includes a fifth action pattern. The action pattern corresponding to (associated with) the sixth lighting state in the corresponding pattern information PAT includes a sixth action pattern. The rule indicated by the rule information RUL includes prohibiting a transition from the fifth action pattern to the sixth action pattern for the no-reaction time tn. Until the no-reaction time tn elapses after the lighting state changes from the fifth lighting state to the sixth lighting state, the action pattern setting unit 20 rejects the transition from the fifth action pattern to the sixth action pattern and maintains the fifth action pattern. After the no-reaction time tn elapses after the lighting state changes from the fifth lighting state to the sixth lighting state, the action pattern setting unit 20 executes the transition from the fifth action pattern to the sixth action pattern.

### 4-3. Effects

According to the present embodiment, the action pattern is prohibited from transitioning to the action pattern PX until the no-reaction time tn elapses after the lighting state of the traffic signal SG changes to the unclear lighting state LX. As a result, it is possible to prevent the short unclear lighting state LX from affecting the action pattern and thus to stabilize the action pattern.

It should be noted that the fourth embodiment can be combined with any of the second and third embodiments described above.

### 5. Fifth Embodiment

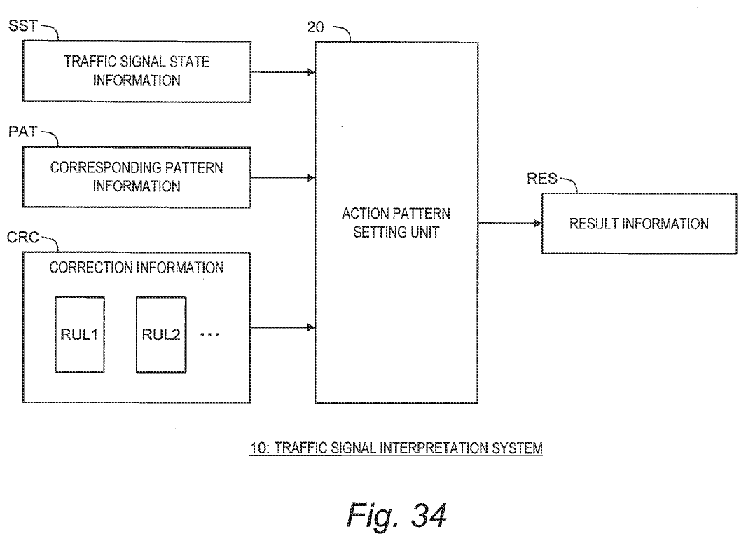

FIG. 34 is a block diagram showing a functional configuration example of the traffic signal interpretation system 10 according to a fifth embodiment. An overlapping description with the foregoing embodiments will be omitted as appropriate. Types of the lighting state of the traffic signal SG may differ depending on a type of the traffic signal SG. Therefore, different rule-information RUL (RUL1, RUL2 . . . ) is provided for each type of the traffic signal SG.

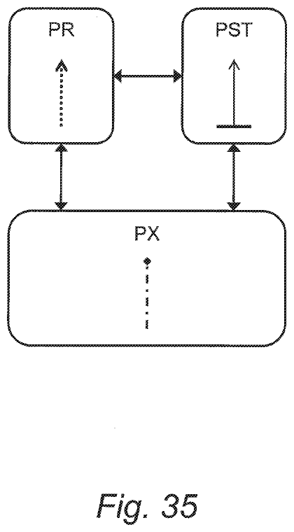

FIG. 35 is a conceptual diagram showing an example of the rule information RUL with regard to the traffic signal SG installed at the railroad crossing (see FIGS. 14 and 15). As shown in FIG. 14, the action pattern corresponding to the lighting state LC1 is the action pattern PR. As shown in FIG. 15, the action pattern corresponding to the lighting state LC2 is the action pattern PST. The rule information RUL gives a rule about transitions between the action pattern PR, the action pattern PST, and the action pattern PX. When the lighting state indicated by the traffic signal state information SST is the lighting state LC1 or the lighting state LC2, the action pattern setting unit 20 selects and uses the rule information RUL shown in FIG. 35.

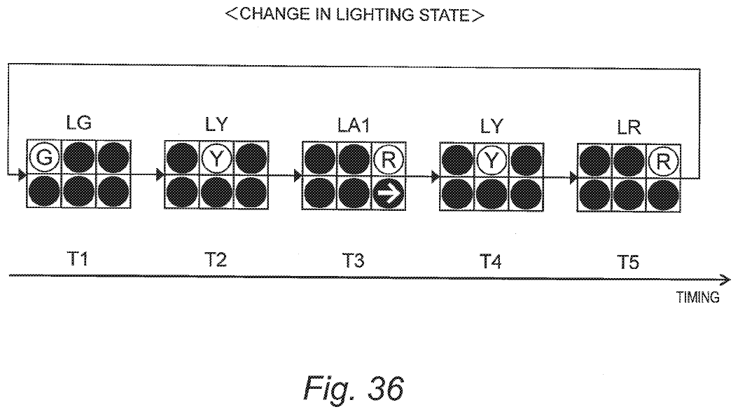

FIGS. 36 to 38 are conceptual diagrams for explaining another example of the rule information RUL.

FIG. 36 shows an example of a repetition pattern of the lighting state of the traffic signal SG. As compared with the foregoing example shown in FIG. 24, the lighting state LR (red light) between the lighting state LY (yellow light) and the lighting state LA1 (red light+right arrow signal) is omitted. That is, the lighting state of the traffic signal SG directly changes from the lighting state LY to the lighting state LA1 without through the lighting state LR.

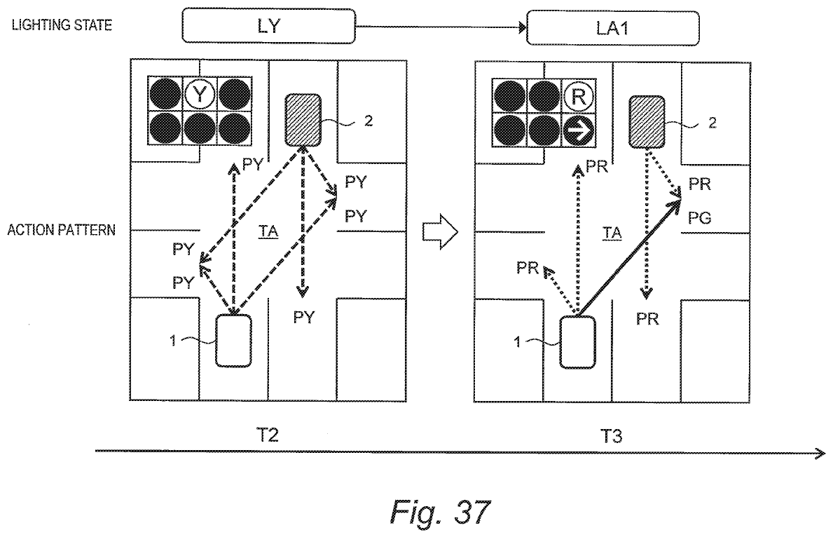

FIG. 37 shows the transition of the action pattern accompanying the change from the lighting state LY to the lighting state LA1. The action pattern of vehicle 1 in the right-turn direction transitions from the action pattern PY to the action pattern PG, which is an appropriate transition. Therefore, when the lighting state directly changes from the lighting state LY to the lighting state LA1, the transition from the action pattern PY to the action pattern PG may be exceptionally permitted.

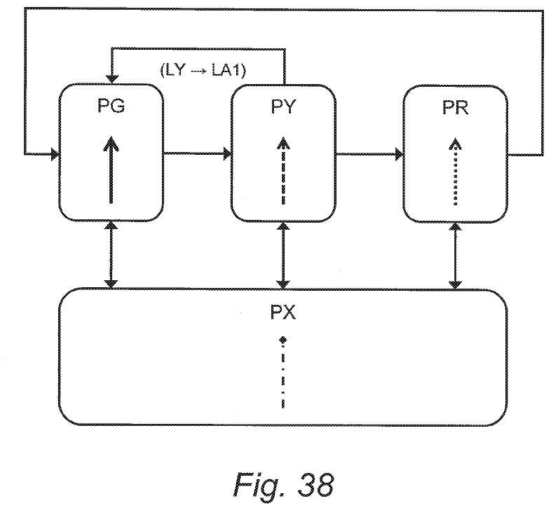

FIG. 38 shows the rule information RUL generated from the above point of view. Basically, the transition from action pattern PY to the action pattern PG is prohibited. However, only when the lighting state directly changes from the lighting state LY to the lighting state LA1, the transition from the action pattern PY to the action pattern PG is permitted. When the lighting state indicated by the traffic signal state information SST directly changes from the lighting state LY to the lighting state LA1, the action pattern setting unit 20 selects and uses the rule information RUL shown in FIG. 38.

A rule information database that associates the position of the traffic signal SG in the absolute coordinate system with the rule information RUL may be prepared in advance. The position in the absolute coordinate system of the traffic signal SG detected based on the camera image information IMG can be calculated from the position information POS and the camera image information IMG. The traffic signal state information SST includes the position of the detected traffic signal SG in the absolute coordinate system. The action pattern setting unit 20 refers to the rule information database to select the rule information RUL associated with the position indicated by the traffic signal state information SST.

### 6. Sixth Embodiment

### 6-1. Outline

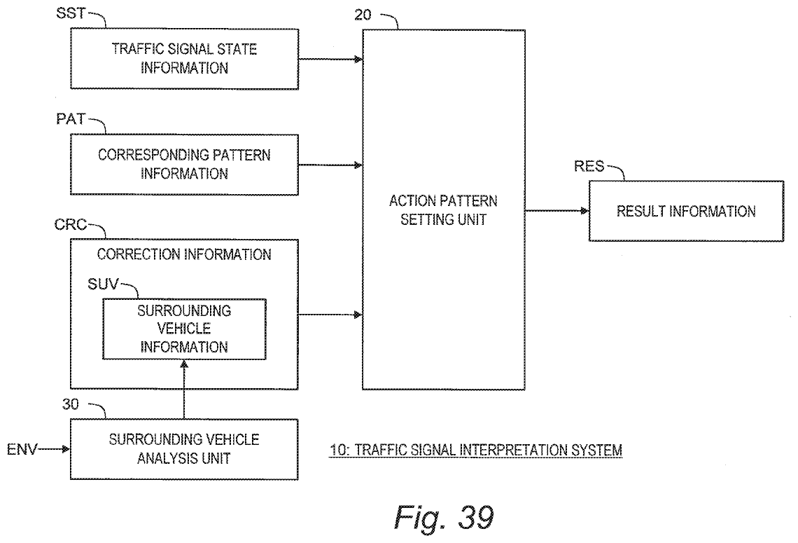

FIG. 39 is a block diagram showing a functional configuration example of the traffic signal interpretation system 10 according to a sixth embodiment. An overlapping description with the first embodiment will be omitted as appropriate. The traffic signal interpretation system 10 according to the present embodiment further includes a surrounding vehicle analysis unit 30. The surrounding vehicle analysis unit 30 is a functional block of the processor 150 (see FIG. 18) or the processor 250 (see FIG. 20).

The surrounding vehicle analysis unit 30 analyzes a state of a surrounding vehicle around the vehicle 1 based on the driving environment information ENV and generates surrounding vehicle information SUV indicating a result of the analysis. For example, the surrounding vehicle information SUV indicates a position, a speed, and an acceleration of the surrounding vehicle in the absolute coordinate system. In addition, the surrounding vehicle information SUV indicates a vehicle behavior of the surrounding vehicle with respect to the target area TA. The vehicle behavior of the surrounding vehicle with respect to the target area TA is exemplified by “stopped/will stop”, “start moving/move”, and “unknown.”

More specifically, the driving environment information ENV includes the position information POS, the surrounding situation information SIT, and the vehicle state information STA (see FIG. 19). The position information POS indicates the position and the orientation of the vehicle 1 in the absolute coordinate system. The surrounding situation information SIT includes the relative position and the relative velocity of the surrounding vehicle with respect to the vehicle 1. The vehicle state information STA includes the speed of the vehicle 1. It is therefore possible to calculate the position, the speed, the acceleration, and the like of the surrounding vehicle in the absolute coordinate system based on the driving environment information ENV.

In addition, the vehicle behavior of the surrounding vehicle can be determined based on the position, the speed, and the acceleration of the surrounding vehicle. For example, when a position of a surrounding vehicle is before a stop line, its speed is lower than a first speed threshold, and its acceleration is equal to or lower than zero, it is determined that the vehicle behavior of the surrounding vehicle is “stopped/will stop.” The position of the stop line is obtained from the map information MAP or the surrounding situation information SIT. The first speed threshold may be a function of a distance from the surrounding vehicle to the stop line. When a speed of a surrounding vehicle is equal to or higher than a second speed threshold and its acceleration is equal to or higher than zero, it is determined that the vehicle behavior of the surrounding vehicle is “start moving/move.” The second speed threshold may be a function of the distance between the surrounding vehicle and the stop line. In other cases, the vehicle behavior of the surrounding vehicle is determined to be “unknown.”

According to the present embodiment, the correction information CRC includes the surrounding vehicle information SUV. The action pattern setting unit 20 sets the final action pattern with respect to the target area TA by correcting the provisional action pattern based on the surrounding vehicle information SUV. More specifically, the action pattern setting unit 20 corrects the provisional action pattern so as to be consistent with the vehicle behavior of the surrounding vehicle. It is thus possible to more appropriately set the action pattern with respect to the target area TA.

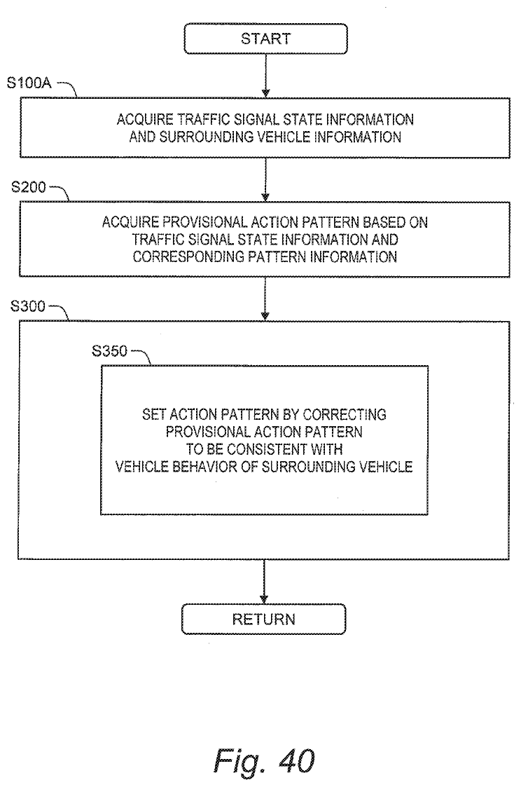

FIG. 40 is a flow chart showing processing by the traffic signal interpretation system 10 according to the present embodiment.

In Step S100A, the action pattern setting unit 20 acquires the latest traffic signal state information SST. In addition, the surrounding vehicle analysis unit 30 acquires the latest surrounding vehicle information SUV. Step S200 is the same as in the case of the first embodiment.

Step S300 (action pattern correcting processing) includes Step S350. In Step S350, the action pattern setting unit 20 sets the final action pattern with respect to the target area TA by correcting the provisional action pattern so as to be consistent with the vehicle behavior of the surrounding vehicle.

### 6-2. Examples of Application

Hereinafter, examples of application of the traffic signal interpretation system 10 according to the present embodiment will be described.

### 6-2-1. First Example of Application

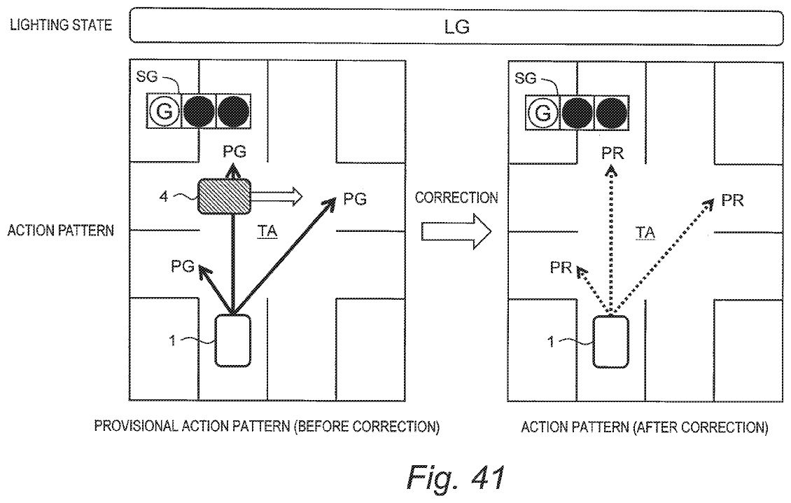

FIG. 41 is a conceptual diagram for explaining a first example of application. The target area TA is an intersection. Let us consider a situation immediately after the lighting state of the traffic signal SG installed at the intersection changes from the lighting state LR (red light) to the lighting state LG (green light). In this situation, an intersecting vehicle 4 traveling in the intersecting direction still remains in the intersection. In this case, it is not desirable from a viewpoint of safety that the vehicle 1 immediately enters the intersection. In other words, it is not necessarily appropriate to set the action pattern of the vehicle 1 based only on the lighting state of the traffic signal SG.

In view of the above, correction of the action pattern of the vehicle 1 is performed based on the surrounding vehicle information SUV. More specifically, the provisional action pattern of the vehicle 1 corresponding to the lighting state LG in the corresponding pattern information PAT is the action pattern PG. On the other hand, the surrounding vehicle information SUV indicates that the intersecting vehicle 4 traveling in the intersecting direction exists in the intersection. The lighting state consistent with the vehicle behavior of the intersecting vehicle 4 is the lighting state LR (red light). Therefore, the action pattern of the vehicle 1 also is set to the action pattern PR so as to be consistent with the vehicle behavior of the intersecting vehicle 4. In this manner, a more appropriate action pattern is set.

### 6-2-2. Second Example of Application

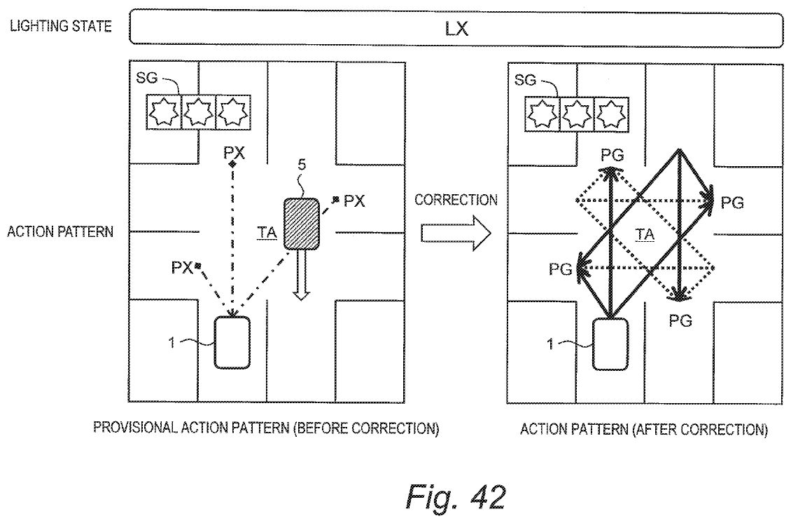

FIG. 42 is a conceptual diagram for explaining a second example of application. The target area TA is an intersection. The lighting state of the traffic signal SG indicated by the traffic signal state information SST is the unclear lighting state LX. On the other hand, an oncoming vehicle 5 in an oncoming lane starts moving toward the intersection or is moving in the intersection. This means that a lighting state of a traffic signal (not shown) for the oncoming lane is the lighting state LG (green light). Therefore, it is presumed that the lighting state of the traffic signal SG also is the lighting state LG (green light).

In view of the above, correction of the action pattern of the vehicle 1 is performed based on the surrounding vehicle information SUV. More specifically, the provisional action pattern of the vehicle 1 corresponding to the lighting state LX in the corresponding pattern information PAT is the action pattern PX. On the other hand, the surrounding vehicle information SUV indicates that the oncoming vehicle 5 starts moving toward the intersection or is moving in the intersection. The lighting state consistent with the vehicle behavior of the oncoming vehicle 5 is the lighting state LG (green light). Therefore, the action pattern of the vehicle 1 also is set to the action pattern PG so as to be consistent with the vehicle behavior of the oncoming vehicle 5. In this manner, a more appropriate action pattern is set.

### 6-2-3. Third Example of Application

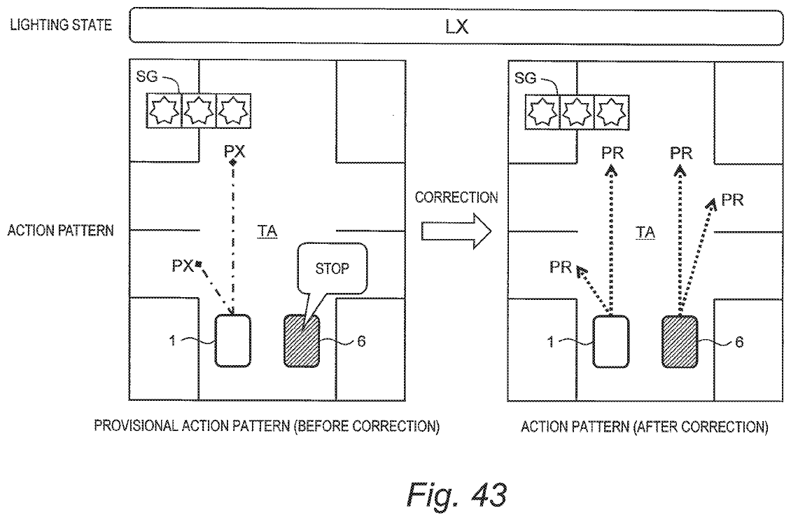

FIG. 43 is a conceptual diagram for explaining a third example of application. The target area TA is an intersection. The lighting state of the traffic signal SG indicated by the traffic signal state information SST is the unclear lighting state LX. On the other hand, an adjacent vehicle 6 which exists in the same lane as the vehicle 1 is stopped before a top line. Therefore, it is presumed that the lighting state of the traffic signal SG is the lighting state LR (red light).

In view of the above, correction of the action pattern of the vehicle 1 is performed based on the surrounding vehicle information SUV. More specifically, the provisional action pattern of the vehicle 1 corresponding to the lighting state LX in the corresponding pattern information PAT is the action pattern PX. On the other hand, the surrounding vehicle information SUV indicates that the adjacent vehicle 6 is stopped before the stop line. The lighting state consistent with the vehicle behavior of the adjacent vehicle 6 is the lighting state LR (red light). Therefore, the action pattern of the vehicle 1 also is set to the action pattern PR so as to be consistent with the vehicle behavior of the adjacent vehicle 6. In this manner, a more appropriate action pattern is set.

### 6-2-4. Fourth Example of Application

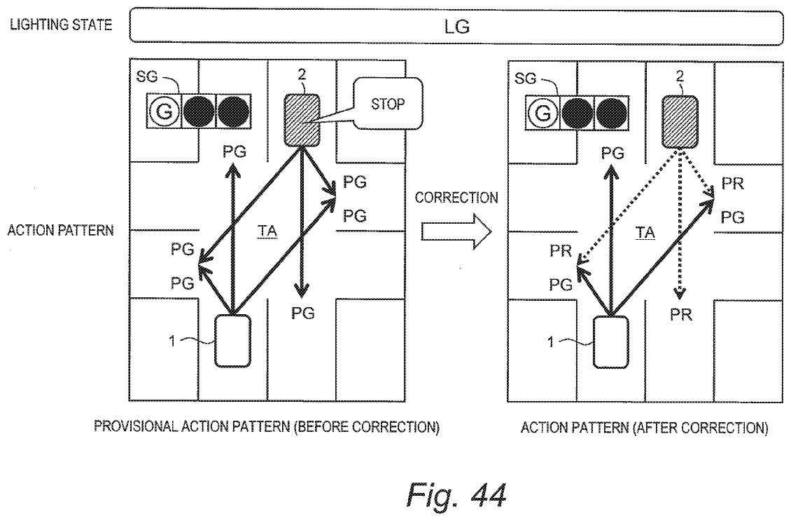

FIG. 44 is a conceptual diagram for explaining a fourth example of application. The target area TA is an intersection where a time-difference type traffic signal is installed. The time-difference type traffic signal can be recognized, for example, by utilizing traffic signal map information. The traffic signal map information indicates a “position in the absolute coordinate system” and a “type” of the traffic signal SG which are associated with each other. The position in the absolute coordinate system of the traffic signal SG detected based on the camera image information IMG can be calculated from the position information POS and the camera image information IMG. Then, it is possible to know the type of the traffic signal SG (here, the time-difference type traffic signal) by referring to the traffic signal map information.

The lighting state of the traffic signal SG indicated by the traffic signal state information SST is the lighting state LG (green light). On the other hand, an oncoming vehicle 2 present in an oncoming lane is stopped before a stop line. Therefore, it is presumed that a lighting state of a traffic signal (not shown) for the oncoming lane is the lighting state LR (red light).

In view of the above, correction of the action pattern of the oncoming vehicle 2 is performed based on the surrounding vehicle information SUV. More specifically, the provisional action pattern of the oncoming vehicle 2 corresponding to the lighting state LG in the corresponding pattern information PAT is the action pattern PG. On the other hand, the surrounding vehicle information SUV indicates that the oncoming vehicle 2 is stopped before the stop line. The lighting state consistent with the vehicle behavior of the oncoming vehicle 2 is the lighting state LR (red light). Therefore, the action pattern of the oncoming vehicle 2 is set to the action pattern PR so as to be consistent with the vehicle behavior of the oncoming vehicle 2. In this manner, a more appropriate action pattern is set.

### 6-2-5. Fifth Example of Application

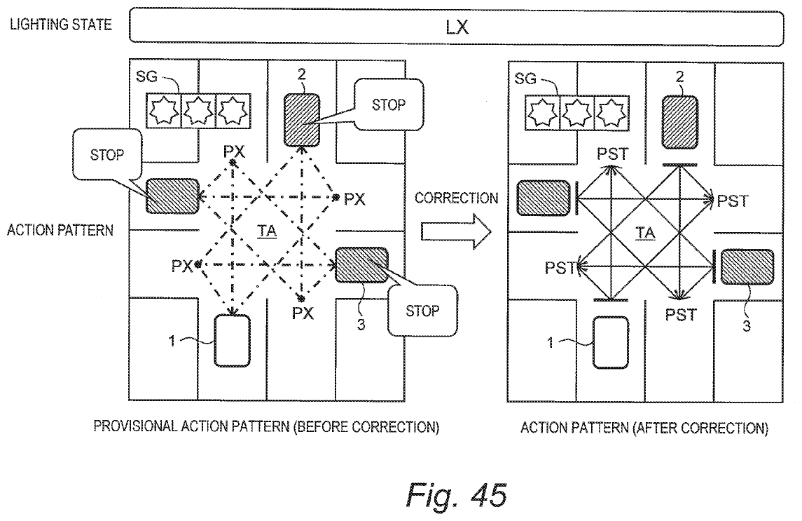

FIG. 45 is a conceptual diagram for explaining a fifth example of application. The target area TA is an intersection. Let us consider a situation where all traffic signals installed at the intersection are in the unlighted state due to power outage or failure. The lighting state of the traffic signal SG indicated by the traffic signal state information SST is the unclear lighting state LX. In this situation, at least one of the oncoming vehicle 2 and the intersecting vehicle 3 is stopped before a stop line. In this case, the vehicle 1 may proceed carefully after stop.

In view of the above, correction of the action pattern of the vehicle 1 is performed based on the surrounding vehicle information SUV. More specifically, the provisional action pattern of the vehicle 1 corresponding to the lighting state LX in the corresponding pattern information PAT is the action pattern PX. On the other hand, the surrounding vehicle information SUV indicates that at least one of the oncoming vehicle 2 and the intersecting vehicle 3 is stopped before the stop line. The action pattern of the vehicle 1 is set to the action pattern PST so as to be consistent with the vehicle behavior of at least one of the oncoming vehicle 2 and the intersecting vehicle 3. In this manner, a more appropriate action pattern is set.

### 6-3. Effects

According to the present embodiment, as described above, the correction information CRC includes the surrounding vehicle information SUV indicating the vehicle behavior of the surrounding vehicle with respect to the target area TA. The traffic signal interpretation system 10 sets the action pattern by correcting the provisional action pattern so as to be consistent with the vehicle behavior of the surrounding vehicle. It is thus possible to more appropriately set the action pattern with respect to the target area TA.

### 7. Seventh Embodiment

It is also possible to combine the sixth embodiment with any of the other embodiments. In other words, the correction information CRC may include both the rule information RUL and the surrounding vehicle information SUV.

What is claimed is:

1. A traffic signal interpretation system applied to a vehicle executing automated driving,
the traffic signal interpretation system comprising:
one or more processors configured to at least set an action pattern of the vehicle with respect to a target area where a traffic signal is installed; and
one or more memory devices configured to store:
traffic signal state information indicating a lighting state of the traffic signal;
corresponding pattern information indicating a correspondence relationship between the lighting state of the traffic signal and the action pattern; and
rule information indicating a rule that permits or prohibits a transition of the action pattern, wherein
the one or more processors are further configured to:
refer to the corresponding pattern information to acquire the action pattern corresponding to the lighting state indicated by the traffic signal state information as a provisional action pattern; and
when the provisional action pattern becomes one different from a previous action pattern, set a current action pattern by correcting a transition from the previous action pattern to the provisional action pattern so as to be consistent with the rule indicated by the rule information.

2. The traffic signal interpretation system according to claim 1, wherein
when the transition from the previous action pattern to the provisional action pattern follows the rule, the one or more processors set the provisional action pattern as the current action pattern, and
when the transition from the previous action pattern to the provisional action pattern violates the rule, the one or more processors reject the transition and maintain the previous action pattern as the current action pattern.

3. The traffic signal interpretation system according to claim 2, wherein
the lighting state includes a first lighting state and a second lighting state,
the action pattern corresponding to the first lighting state in the corresponding pattern information includes a first action pattern,
the action pattern corresponding to the second lighting state in the corresponding pattern information includes a second action pattern,
the rule includes prohibiting a transition from the first action pattern to the second action pattern, and
when the lighting state changes from the first lighting state to the second lighting state, the one or more processors reject the transition from the first action pattern to the second action pattern and maintain the first action pattern.

4. The traffic signal interpretation system according to claim 2, wherein
the lighting state includes a third lighting state and a fourth lighting state,
the action pattern corresponding to the third lighting state in the corresponding pattern information includes a third action pattern,
the action pattern corresponding to the fourth lighting state in the corresponding pattern information includes a fourth action pattern,
the rule includes: permitting a transition from the third action pattern to the fourth action pattern; permitting a transition from the fourth action pattern to the third action pattern for a temporary permission time; and prohibiting the transition from the fourth action pattern to the third action pattern after an elapse of the temporary permission time,
when the lighting state changes from the third lighting state to the fourth lighting state, the one or more processors execute the transition from the third action pattern to the fourth action pattern,
when the lighting state directly returns from the fourth lighting state to the third lighting state before the temporary permission time elapses after the lighting state changes from the third lighting state to the fourth lighting state, the one or more processors execute the transition from the fourth action pattern to the third action pattern, and
when the lighting state directly returns from the fourth lighting state to the third lighting state after the temporary permission time elapses after the lighting state changes from the third lighting state to the fourth lighting state, the one or more processors reject the transition from the fourth action pattern to the third action pattern and maintain the fourth action pattern.

5. The traffic signal interpretation system according to claim 2, wherein
the lighting state includes a fifth lighting state and a sixth lighting state meaning unclear,
the action pattern corresponding to the fifth lighting state in the corresponding pattern information includes a fifth action pattern,
the action pattern corresponding to the sixth lighting state in the corresponding pattern information includes a sixth action pattern,
the rule includes prohibiting a transition from the fifth action pattern to the sixth action pattern for a no-reaction time,
until the no-reaction time elapses after the lighting state changes from the fifth lighting state to the sixth lighting state, the one or more processors reject the transition from the fifth action pattern to the sixth action pattern and maintain the fifth action pattern, and
after the no-reaction time elapses after the lighting state changes from the fifth lighting state to the sixth lighting state, the one or more processors execute the transition from the fifth action pattern to the sixth action pattern.

6. A traffic signal interpretation system applied to a vehicle executing automated driving,
the traffic signal interpretation system comprising:
one or more processors configured to at least set an action pattern of the vehicle with respect to a target area where a traffic signal is installed; and
one or more memory devices configured to store:
traffic signal state information indicating a lighting state of the traffic signal;
corresponding pattern information indicating a correspondence relationship between the lighting state of the traffic signal and the action pattern; and
surrounding vehicle information indicating a vehicle behavior of a surrounding vehicle around the vehicle with respect to the target area, wherein
the one or more processors are further configured to:
refer to the corresponding pattern information to acquire the action pattern corresponding to the lighting state indicated by the traffic signal state information as a provisional action pattern; and
set the action pattern by correcting the provisional action pattern so as to be consistent with the vehicle behavior of the surrounding vehicle.

7. A vehicle control system applied to a vehicle executing automated driving,
the vehicle control system comprising:
one or more processors configured to:
set an action pattern of the vehicle with respect to a target area where a traffic signal is installed;
generate a travel plan of the vehicle during the automated driving based on the action pattern; and
control the vehicle to travel in accordance with the travel plan; and
one or more memory devices configured to store:
traffic signal state information indicating a lighting state of the traffic signal;
corresponding pattern information indicating a correspondence relationship between the lighting state of the traffic signal and the action pattern; and
rule information indicating a rule that permits or prohibits a transition of the action pattern, wherein
the one or more processors are further configured to:
refer to the corresponding pattern information to acquire the action pattern corresponding to the lighting state indicated by the traffic signal state information as a provisional action pattern; and
when the provisional action pattern becomes one different from a previous action pattern, set a current action pattern by correcting a transition from the previous action pattern to the provisional action pattern so as to be consistent with the rule indicated by the rule information.
